(19) United States
(12) Patent Application Publication
(10) Pub. No.: US 2024/0356625 A1
(43) Pub. Date: Oct. 24, 2024

(54) RECONFIGURABLE RELAY DISCOVERY FOR BLINDSPOT AVOIDANCE

(71) Applicant: KONINKLIJKE PHILIPS N.V., EINDHOVEN (NL)

(72) Inventors: Nicholas Walker, Eindhoven (NL); Timothy Beard, Eindhoven (NL); Esko Olavi Dijk, Utrecht (NL); Oscar Garcia Morchon, Eindhoven (NL); Harry Michael Cronin, Eindhoven (NL); Walter Dees, Eindhoven (NL)

(21) Appl. No.: 18/685,960

(22) PCT Filed: Aug. 25, 2022
(86) PCT No.: PCT/EP2022/073679

§ 371 Date: Feb. 23, 2024

(30) Foreign Application Priority Data
Aug. 27, 2021 (EP) 21193626.5
Nov. 3, 2021 (EP) 21206258.2
Aug. 8, 2022 (EP) 22189327.4
Aug. 10, 2022 (EP) 22189615.2

(51) Int. Cl. H04B 7/155; H04W 60/00

(52) U.S. Cl. CPC H04B 7/15528; H04W 60/00

(57) ABSTRACT

The invention proposes a system and method for determining and controlling a reconfigurable relay device (e.g., a reconfigurable intelligent surface, RIS, or a smart repeater), wherein the reconfigurable relay device is registered and a wireless communication path is established from a network (e.g. access device) via the reconfigurable relay device to a terminal device. The network registers the reconfigurable relay device and determines parameters needed for its control. The control may be achieved by validated and accepted commands and queries. A relay state of the relay device may be set so that a beam for the wireless communication path is correctly redirected at the terminal device.

### FIELD OF THE INVENTION

The invention relates to the field of communication services for terminal devices including mobile access devices in wireless networks, such as—but not limited to—reconfigurable intelligent surfaces (RISs).

### BACKGROUND OF THE INVENTION

Whilst Reconfigurable Intelligent Surfaces (RIS) can be constructed using any technology with the appropriate characteristics (e.g., an ability to redirect, that is, reflect or transmit in different configurations radio waves of the correct frequencies), the predominant technology used is metamaterial surfaces, or “metasurfaces” in short.

Switchable metasurfaces have been recently developed and offer many possibilities for improving a wireless communication path between an access device (e.g., base station or access point) of a wireless network and a terminal device (e.g., user equipment (UE)).

A variety of technologies can be employed to implement such switchable metasurfaces. Generally, electronically switched metasurfaces are employed, but physically moveable reflecting patches are also a viable technology. In general, as long as the general set of desired properties are implemented, there is no reason that these surfaces cannot be constructed by using any relevant technology. Metasurfaces can even be used to form independent communications infrastructures using backscattered ambient radio signals.

Metasurfaces may be composed of periodic subwavelength metal/dielectric antennae that resonantly couple to the electric or magnetic or both components of the incident electromagnetic fields, exhibiting effective electric (represented by electric permittivity a) and/or magnetic (represented by magnetic permeability p) responses not found in nature.

Thus, metasurfaces represent a versatile concept for the manipulation of electromagnetic waves. Due to the ease of fabrication using planar circuit manufacturing, there is significant application potential for the microwave frequency range. Huygens metasurfaces have received significant attention as they feature near unity transmission and suppress reflection artifacts efficiently. For microwave frequencies, Huygens metasurfaces are usually manufactured in printed circuit board (PCB) processes with three structured copper layers separated by low-loss dielectric substrates.

Metamaterials will be useful in many aspects of e.g. 5G wireless communication solutions. Syed S. Bukhari et al.: “A Metasurfaces Review: Definitions and Applications” provides a review of metasurfaces. Purely passive metasurfaces are useful, but only act as permanent changes to the transmission environment.

A reconfigurable metasurface for mm-wave networks (“mmWall”) has been proposed by Kun Woo Cho et al.: “mmWall: A Reconfigurable Metamaterial Surface for mmWave Networks”, which is a tunable smart surface made of metamaterial which, unlike a conventional wireless relay system, does not have transmitting and receiving antennas, nor an amplifier. Once the incoming beam hits the metasurface, it naturally refracts the beam into a desired direction, regardless of whether the transmitter and receiver are located in the same room (“mirror” mode) or in a different room (“lens” mode). Also, it can split the incoming signal into multiple beams and concurrently steer the multi-armed beams. The authors used “Huygen's metasurfaces” to implement their design.

There are however other technologies for switchable mm-wave manipulating surfaces apart from metasurfaces.

Furthermore, Large Intelligent Surfaces (LIS) and a model for integration of base stations and LIS to determine the benefits of different proportions of each in a communications network has been disclosed in Yongxu Zhu et al.: “Stochastic Geometry Analysis of Large Intelligent Surface- Assisted Millimeter Wave Networks”. They concluded that, where there are a limited number of base stations, the contribution of LIS is good, but this is not the case where there are very many base stations serving users.

Moreover, in Jun Zhao et al.: “A Survey of Intelligent Reflecting Surfaces (IRSs): Towards 6G Wireless Communication Networks”, the authors term the surfaces “Intelligent Reflecting Surfaces” and the behavior is limited to reflection rather than both reflection and transmission.

### SUMMARY OF THE INVENTION

It is an object of the present invention to enable control and use of reconfigurable relay device, such as externally controlled RISs which lack intrinsic capacity to perform their own radio sensing (“fully passive RIS”), and partially active RISs which may include e.g. some radio capabilities, signal processing capabilities, sensors, motors to change orientation of individual sub-panels/sub-elements of the RIS, or active elements to not only modify the angle/polarization of the reflected electromagnetic wave, but also to amplify it etc.

This object is achieved by an apparatus as claimed in claim 1, by an access device, by a reconfigurable relay device as claimed in claim 7, by a system as claimed in claim 14, by a method as claimed in claim 15, and by a computer program product

According to a first aspect related to an access device (e.g. base station (gNB) or access point), an apparatus is provided for controlling a communication path in a wireless network, the apparatus comprising:
a registration controller for discovering and registering a reconfigurable relay device in the wireless network;
a path establisher for determining and establishing a wireless communication path to at least one target terminal device via at least one registered reconfigurable relay device; and
a state controller for controlling a redirection pattern of the at least one reconfigurable relay device in accordance with the established wireless communication path.

According to a second aspect related to the access device (e.g. base station (gNB) or access point), a method is provided for controlling a communication path in a wireless network, the method comprising:
discovering and registering a reconfigurable relay device in the wireless network;
planning and establishing a wireless communication path to at least one target terminal device via at least one registered reconfigurable relay device; and
controlling a redirection pattern of the at least one reconfigurable relay device in accordance with the established wireless communication path.

According to a third aspect, a reconfigurable relay device (e.g. an RIS or a smart repeater) is provided, which is configured to control a redirection pattern for relaying at least one received wireless signal in response to a command received from a remote controller device of a wireless network to establish a wireless communication path to a target terminal device, wherein the reconfigurable relay device can be set to one of a plurality of configuration states in response to the command, wherein each of the configuration states results in one of a plurality of redirection patterns of the received wireless signal, and wherein the plurality of redirection patterns comprise at least one of a reflection with a given reflection angle, a focusing or defocusing, a generation of multiple beams, a refraction with a given refraction angle, an amplification with a given amplify gain, or an absorption.

According to a fourth aspect, an access device is provided, which comprises the apparatus of the first aspect.

According to a fifth aspect, a system is provided, which comprises at least one access device of the fourth aspect, at least one reconfigurable relay device of the third aspect, and a relay installation database for storing information about installed reconfigurable relay devices.

Finally, according to a sixth aspect, a computer program product is provided, which comprises code means for producing the steps of the method of the second aspect when run on a computer device.

The proposed path establishment via at least one reconfigurable relay device offers significant benefits for radio communication systems, particularly those using high frequencies such as 5G mm-wave. This is because such frequencies are readily absorbed by many materials and thus blind spots are more common with these systems.

A scenario for installation of an RIS is that an owner of a building wants to improve reception quality of wireless communications, e.g., 5G based, within the building. The occupants of the building might be his/her own staff, an Industrial Internet of Things (IIoT) network or possibly the general public (e.g., in a public building). More likely, the owner might wish to improve reception on all wireless communication networks supplying individuals in the building. Therefore, it may be desirable that the surfaces are used by all networks to improve communications with the people inside the building. Therefore, the owners of the devices would wish to enable them to be integrated with the operations of the wireless communication, e.g., 5G based, network operators.

A priority ordering of networks might be determined, for example by the statistics of the networks supplying users within that building. Moreover, several networks might be given paid access to the RIS, possibly setting priorities on use of the RIS according to an auction or fixed fee charged for 1st place, 2nd place etc within the controller priority list.

Systems with reconfigurable relay devices such as RISs or smart repeaters are likely to be significantly cheaper than additional base stations. The proposed reconfigurable relay devices may be “passive” in the sense that they are controlled by an external controller, most likely a core network device or an access device (e.g., base station) performing the search for communication paths. It is possible to integrate some form of radio sensing and internal control into these systems, whereby the reconfigurable relay device becomes responsible for setting its state based on e.g. beam search to the target terminal device.

Specifically, the following advantages can be achieved:
Installed reconfigurable relay devices or systems can be setup to be controlled by one or more networks in a way which enables their valid and secure operation in communication systems, and which handles edge cases such as non-operation of a reconfigurable relay system.
The operation of multiple networks seeking to use a single reconfigurable relay device at the same time in setting up communication paths can be handled.
Means can be provided for rapid calculation of a radio frequency (RF) communication signal path via such a reconfigurable relay device from an access device to a terminal device.
Additional independent communication paths can be established, for example two UEs located in the same direction from the access device can be served on the same frequency by beam forming directly towards one and beam forming via a reconfigurable relay device to the other, or for two access devices beaming towards two UEs respectively, for one to use a path via the reconfigurable relay device (even though there is a direct line of sight (LoS) to that UE) to again avoid interference if that LoS path would impact the other UE and the relay-directed path would not.

Accordingly, newly installed reconfigurable relay systems can be registered such that the network or access device has an ability to command them to desired states, including discovery methods if a formal registration process for the reconfigurable relay device is not available. This allows discovery, setup and ongoing operation of the control of a fully passive reconfigurable relay device by the network or its access devices. Moreover, competition over control of purely passive reconfigurable relay device between different networks and/or network operators is allowed. Even when a reconfigurable relay device is formally registered (by itself or by its owner) in a database, the access device may still need to discover or try out that reconfigurable relay device if it is reachable from the access device and whether it can help to establish useful communication paths to terminal devices.

Additionally, the proposed solution provides an optimum approach to finding a communication path to a UE via a reconfigurable relay device, given that the access device (e.g., base station) provides a potentially large number of beam formed directions, only a few of which interact with the reconfigurable relay device, and that there may be a very large number of states for the reconfigurable relay device, most of which result in no communication path to the terminal device or there may be very many individual elements in a reconfigurable relay device so that checking through each element is not feasible.

Furthermore, queries and commands to the reconfigurable relay systems can be formatted and sent to support their use in communication with end users where the command/query communication meets security and acceptability requirements (e.g., the network has appropriate priority and authorization for use of a reconfigurable relay device if required).

Moreover, the proposed system can be applied in outdoor and indoor environments as well. A likely scenario may be the improvement of connectivity outdoors, e.g., in city scenarios where due to buildings, cars, etc. the reception quality might not be as good as desirable. In this scenario, RISs installed in the city environment, e.g., in building facades, billboards, etc. are used by network operators to improve network connectivity and services.

According to a first option which may be combined with any of the above first to sixth aspects, the reconfigurable relay device may be looked up (e.g. by the registration controller) in a relay installation database and a required registration method may be queried from the relay installation database or the reconfigurable relay device or identity information and metadata may be obtained from the reconfigurable relay device, or identity information and metadata may be received from the reconfigurable relay device (20) upon the relay configurable relay device attaching or registering to the wireless network, or the reconfigurable relay device may be discovered by using autodiscovery in a locality method where local transmission paths with variable properties are noted. Thereby, path establishment can be adapted to new network configurations to ensure optimal communication paths.

According to a second option which may be combined with the first option or any of the above first to sixth aspects, the path establishment may be configured to apply a transmission modelling within a local radio transmission model of a local environment to search for suitable beam paths, or to use results of previous beam directions plus relay states and UE locations stored in a database, or to use a feedback loop by using measurements from a target terminal device to change the angles or further narrowing a beam of the signals transmitted via the reconfigurable relay device, or to use an artificial intelligence model for learning a relation or association between beam settings and parameters, relay states of nearby reconfigurable relay devices and/or UE location(s) as input parameters and link quality and/or performance to the target terminal device as output parameters. Thus, communication paths which include relevant reconfigurable relay systems can be planned, avoiding exhaustive real-world search through beam directions of access devices and relay states.

According to a third option which can be combined with the first or second option or any of the above first to sixth aspects, the redirection pattern applied to at least one beam on the wireless communication path may be controlled by using a scheduling request. Thereby, scheduling considerations for future configuration states of the reconfigurable relay device can be added to the control actions.

According to a fourth option which can be combined with any of the first to third options or any of the above first to sixth aspects, a timing advance can be applied in path establishment to compensate for a longer transmission path length via the reconfigurable relay device. This measure ensures that reception times at the target terminal device can be properly controlled.

According to a fifth option which can be combined with any of the first to fourth options or any of the above first to sixth aspects, the reconfigurable relay device may be queried to determine a current configuration state. Thereby, current redirection patterns of the reconfigurable relay device can be considered in the path planning and establishment process.

According to a sixth option which can be combined with any of the first to fifth options or any of the above first to sixth aspects, the reconfigurable relay device may be a reconfigurable intelligent surface or other switchable metamaterial surface or a smart repeater. Thus, switchable metamaterial surfaces and/or reconfigurable intelligent surfaces can be combined with smart repeaters or they can be selected for achieving an optimized network environment.

According to a seventh option which can be combined with any of the first to sixth options or any of the above first to sixth aspects, the reconfigurable relay device may comprise metadata including at least one of information required for deriving capabilities of the reconfigurable relay device and its control by a network, location and/or orientation information, a set of configuration states, a default configuration state, a reconfiguration speed, authentication, control and query methods, and a network control prioritization information. This option increases efficiency of path planning and establishment by providing a variety of initial information.

According to an eighth option which can be combined with any of the first to seventh options or any of the above first to sixth aspects, the reconfigurable relay device may comprise current information data including at least one of a current relay state indicating a currently set configuration state, a current controller priority parameter(e.g. priority number) which is set to a priority of a current controller, a first flag indicating if the current relay state is being currently commanded, a timer value indicating for how long the current relay state has been commanded, and a second flag indicating an out of operation state. This option increases efficiency of path planning and establishment by providing enhanced information about the current state of the reconfigurable relay device. For example, it can be determined whether a registered reconfigurable relay device is no longer functional, so that it can be removed from the possible communication paths with end user UEs.

According to a ninth option which can be combined with any of the first to eighth options or any of the above first to sixth aspects, the reconfigurable relay device may comprise at least one sensor for obtaining a location and/or orientation of the reconfigurable relay device. Thereby, the reconfigurable relay device can obtain direct information about its location and/or orientation, which may be signaled to a database, or (directly/indirectly) to a controlling access device that can use it for path planning.

According to a tenth option which can be combined with any of the first to ninth options or any of the above first to sixth aspects, the reconfigurable relay device may comprise a network usage log which stores information about usage times of the relay device. This log information can be used to derive usage information for evaluating efficiency and/or proper placing of the reconfigurable relay device.

According to an eleventh option which can be combined with any of the first to tenth options or any of the above first to sixth aspects, the reconfigurable relay device may comprise a priority list for storing priorities of networks or devices that control the reconfigurable relay device, wherein the reconfigurable relay device is configured to compare a new priority of a new remote controller or a new controlling network with a current priority of a current remote controller or a currently controlling network and if the new priority is higher, the reconfigurable relay device ceases the control by the current remote controller or the current network and allows control by the new remote controller or new network. This provides the advantage that priority considerations can be included in path planning and scheduling based on urgency or importance of a communication path. Moreover, a network prioritization scheme can be used to prevent deadlock in the control of a reconfigurable relay device by multiple competing users.

According to a twelfth option which can be combined with any of the first to eleventh options or any of the above first to sixth aspects, the reconfigurable relay device may comprise a scheduler for scheduling configuration states requested by one or more networks or devices and for determining whether a requested configuration state can be accepted or not. Thereby, multiple networks and/or access devices can use the reconfigurable relay device in parallel and total transmission time can be reduced by scheduling same configuration states at same time periods. Additionally, transmissions can be planned in advance (e.g., recurring transmissions), or e.g. in cases where new data for transmission is expected shortly, a pre-scheduled time slot for use of the RIS can be faster than trying to negotiate a RIS at the time of the next transmission.

According to a thirteenth option which can be combined with any of the first to twelfth options or any of the above first to sixth aspects, the reconfigurable relay device may be configured to use a device-to-device communication for communicating with the target terminal device. This provides the advantage of fast direct communication to the target terminal device for efficient path establishment.

According to a fourteenth option which can be combined with any of the first to thirteenth options or any of the above first to sixth aspects, the reconfigurable relay device may be configured to provide a random state cycling where configuration states are randomly changed, or to redirect incident waves or beams towards a predetermined fixed direction, or to enter a configuration state as a metamaterial absorber. Thereby, security can be enhanced, as the reconfigurable relay device can enter a configuration state where it can no longer be used e.g. by networks without permission. Further, as a technical benefit, the random state cycling can prevent attackers to access the system and thus improves the robustness of the wireless system to attacks. Indeed, if a reconfigurable device such as a RIS will modify the communication channel in a random looking manner due to its random state cycling schedule, then this can enhance the robustness of the wireless system not only to prevent networks from using it without permission, but also to prevent users, e.g., attackers, from using wireless signals in the wireless system without permission. In an example, an attacker might be interested in eavesdropping the communication from the network with the purpose of remotely extracting wireless sensing data—e.g., based on the channel state information—that might allow the attacker to learn information about, e.g., the number of users in an environment, their activity, or even their vital signs. The usage of a reconfigurable relay device using random state cycling can minimize the impact of such an attack since the random state cycling will affect the channel limiting the amount of information an attacker can extract from it.

It is noted that the above apparatus may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the apparatus of claim 1, the access device of claim 7, the reconfigurable relay device of claim 8, the system of claim 18, the method of claim 19, and the computer program product of claim 20 may have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 schematically shows a summarizing architecture of an RIS registration and control system according to various embodiments;

FIG. 2 schematically shows a flow diagram of an RIS registration and control method according to various embodiments;

FIG. 3 schematically shows an RIS discovery and registration process according to an embodiment with RIS installation database;

FIG. 4 schematically shows an RIS discovery and registration process according to an embodiment with RIS request for registration;

FIG. 5 schematically shows an RIS discovery and registration process according to an embodiment with autodiscovery;

FIG. 6 schematically shows an RIS query and command process according to an embodiment;

FIG. 7 schematically shows a network control prioritization process according to an embodiment;

FIG. 8 schematically shows a communication path establishment process according to an embodiment with exhaustive search;

FIG. 9 schematically shows a communication path establishment process according to an embodiment with beam path memory;

FIG. 10 schematically shows a failure recognition process according to an embodiment;

FIG. 11 schematically shows a flow diagram of a process for an RIS enabled communication according to various embodiments;

FIG. 12 schematically shows a first example of an improved beam steering process according to an embodiment; and

FIG. 13 schematically shows a second example of an improved beam steering process according to an embodiment.

FIG. 14 schematically shows an example of the management of beam steering process and CSI estimation according to an embodiment.

FIG. 15 schematically shows an example of how a large reflective surface could serve multiple access devices and also how it could be subdivided in multiple sub-RISs.

### DETAILED DESCRIPTION OF EMBODIMENTS

Embodiments of the present invention are now described based on a 5G cellular network environment.

Throughout the present disclosure, the abbreviation “gNB” (5G terminology) or “BS” (base station) is intended to mean access device such as a cellular base station or a WiFi access point. The gNB may consist of a centralized control plane unit (gNB-CU-CP), multiple centralized user plane units (gNB-CU-UPs) and/or multiple distributed units (gNB-DUs). The gNB is part of a radio access network (RAN), which provides an interface to functions in the core network (CN). The RAN is part of a wireless communication network. It implements a radio access technology (RAT). Conceptually, it resides between a communication device such as a mobile phone, a computer, or any remotely controlled machine and provides connection with its CN. The CN is the communication network's core part, which offers numerous services to customers who are interconnected via the RAN. More specifically, it directs communication streams over the communication network and possibly other networks.

Furthermore, the terms “base station” (BS) and “network” are often used as synonyms in this disclosure. This means for example that when it is written that the “network” performs a certain operation it may be performed by a CN function of a cellular network, or by a specific base station that is part of such cellular network, and vice versa. It can also mean that part of the functionality is performed by the cellular network and part of the functionality by the base station.

Additionally, the term “validation” is intended to refer to a process or act that may include typical information technology (IT) security operations such as decryption, signature checking, authentication, authorization etc.

A wide range of names have been given to (large area) surfaces which can passively alter the direction of radio waves impacting on them, but these reflection or transmission properties can be changed and/or switched and/or reconfigured to result in different passive behavior according a “state” they have been set to. These names include intelligent reflective surface (IRS), reconfigurable intelligent surface (RIS), large intelligent surface (LIS), reconfigurable metasurface (RM), programmable metasurface (PM), large intelligent metasurface (LIM), smart reflect-arrays (SRA), software-defined metasurface (SDM), software-defined surface (SDS), passive intelligent surface (PIS), and passive intelligent mirror (PIM).

These surfaces may be switchable between different states, where each state reflects or transmits the radio waves in a different way. A difference existing within these types of surfaces is that some have an intrinsic ability to determine signal strengths, for example they include an ability of a receiver as well as a reflector/transmitter, and therefore can act as an independent “relay-like” system, for example performing their own beam path search (albeit with reflected/transmitted signals originating elsewhere). Their similarity to relays enables them to be integrated into communication standards, e.g., cellular standards, as such.

Such switchable metamaterial surfaces offer many possibilities for improving the communication path between a base station or other type of access device and a terminal device (e.g., UE).

In the following, the term “reconfigurable intelligent surface” or “RIS” will be used to refer to any of the above surface types. In embodiments, it may be assumed that arrays of RISs are fully passive, that is, they have no intrinsic radio sensing capabilities and therefore cannot themselves perform beam search or similar but can be defined by switching states when commanded to by an external controller and it is the responsibility of the external controller to determine the appropriate state to set the RIS to. A RIS may also be partially passive and/or partially active (e.g. include some radio capabilities, signal processing capabilities, sensors, motors to change orientation of individual sub-panels/sub-elements of the RIS).

It is noted that throughout the present disclosure only those blocks, components and/or devices that are relevant for the proposed data distribution function are shown in the accompanying drawings. Other blocks have been omitted for reasons of brevity. Furthermore, blocks designated by same reference numbers are intended to have the same or at least a similar function, so that their function is not described again later.

The following embodiments allow for enhanced network control for a wireless communication involving an access device (e.g., base station (BS)), RIS and terminal device (e.g., UE).

More specifically, RISs may be seamlessly integrated into a 5G network via maintenance by a BS (e.g., gNB in 5G terminology) of a 3D transmission database of the local area, which may include, buildings, objects, neighboring BSs, and which may include all known RISs and their properties (including operations of RISs and means of controlling them). A resulting 3D radio propagation model may be used, along with some limited local search, for selection of communication channels including both the BS beam direction(s) and the states of the RISs controlled by the network and/or BS.

The database may be enhanced by automatic discovery of user-installed RISs (metasurfaces) within the range of coverage. The RISs can be autodiscovered based on an unexpected measured strength of signals between the BS and a UE (or between two or more BSs), where that would not be expected based on the previous iteration of the 3D transmission database (e.g. a 3D area map) and UE reported and/or estimated location. If the properties of the surface are noted to be different at different times, this may be flagged as reconfigurable. When the BS suspects that a new RIS may have been discovered, it can look up the surface and its properties (and perhaps price for use) in a registration database, and if it is found there, the BS may request control capabilities (e.g., from the owner of the RIS) and integrate it (and its properties and control) into the 3D transmission database (e.g., an updated 3D area map).

During usage, the BS performs an analysis of the communication required, which may depend on the estimated locations of (the UEs of) users, and the predictions from its 3D radio propagation model (e.g. based on the above mentioned 3D transmission database). The BS may use its beam forming capabilities and may actively switch/control the behavior of the RISs under its control to maximize communications quality and/or throughput, preferably whilst minimizing the transmission power levels.

### RIS Control Interface and Architecture

The following embodiments cover a registration process, a RIS query and command process, a communication path establishment method from the BS, via the RIS to the UE, a network control prioritization process on command originators (i.e. controllers), and an RIS failure recognition process.

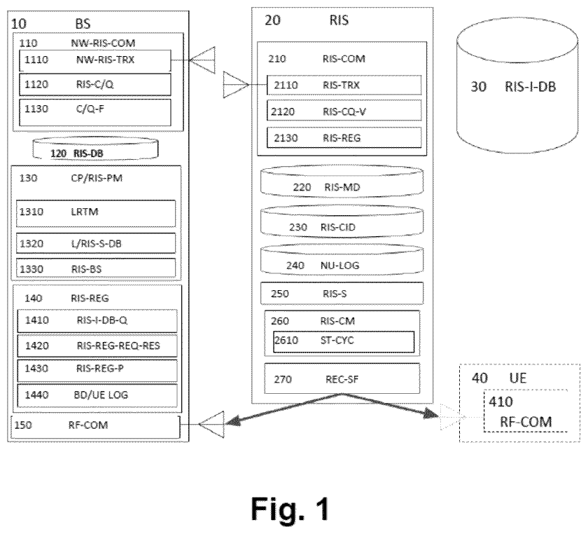

FIG. 1 schematically shows a summarizing architecture (with optional elements and functions) of an RIS registration and control system according to various embodiments.

The proposed system for a RIS enabled communication comprises base stations (BS) 10, at least one reconfigurable intelligent surface (RIS) 20 and terminal devices (UE) 40 of user.

The RIS-controlling base station 10 comprises an RF communication capability (RF-COM) 150 according to the involved communication standard (e.g., 5G NR) and a network to RIS communication system (NW-RIS-COM) 110, also known as state controller, as a means of sending and receiving communications to/from the RIS 20, which may simply be communications to the RIS 20 using its standard communication facilities, e.g., based on the F1-C interface extended with commands/queries for use with a RIS (e.g. to set the RIS state), or may include messages sent to a specified Internet address. It includes a BS to RIS transmission and reception system (NW-RIS-TRX) 1110, an RIS query and command capability (RIS-C/Q) 1120, and a command/query formatting for validation procedure (C/Q-F) 1130.

The UE 40 comprises an RF communication capability (RF-COM) 410 for enabling communication with the BS 10 according to the involved communication standard (e.g., 5G NR).

Furthermore, the BS 10 comprises an optional RIS database (RIS-DB) 120 containing a list of local RISs and their metadata and optionally the BS beam direction to target each RIS. Alternatively, the RIS database may be stored separately (e.g. may be part of a core network function, or application function (e.g. made available through a Network Exposure Function (NEF))). It might just store beam directions to target each specific RIS. Optionally, the metadata sourced from the RIS 20 may be extended to include aspects of its performance as determined by the network or BS 10, such as its optimal beam direction, availability, utility in communication, changes in performance according to weather and time of year etc.

The RIS database 120 may be divided into RIS information which is general to a network controlling many local BSs (e.g. the location of a RIS or the capabilities of a RIS) and information which is specific to individual BSs (e.g. whether a specific UE can be reached via a RIS controlled by that BS). For example, access to a specific RIS may be negotiated for a network operator by any of its BSs and certain information may be generic for that RIS to all BSs. However, the ability to use a specific RIS may differ between the individual BSs, for example an RIS may become obscured for one BS but not for another.

Additionally, the BS 10 comprises a communication path including RIS planning module (CP/RIS-PM) 130 which may include:
An optional local radio transmission model (LRTM) 1310 of its local environment, including the presence, location and behavior of any RISs which can be used to identify a correct configuration of a BS beam direction, selection of RIS and RIS state to communicate with a UE at a defined location. Optionally, the performance of the RIS in the local radio transmission model 1310 may be determined based on the calculated additional RIS database components, such as performance according to weather and time of year.
An optional database (L/RIS-S-DB) 1320 for storing UE location, RIS metadata (e.g. RIS capabilities, RIS location and/or RIS state), and linking a specific RIS, a state setting of that RIS and the location(s) of UEs which were successfully communicated with by the BS 10 using that RIS and RIS state, given one or more UE locations, the identity and location of the RIS (alternatively a beam direction to that RIS), and/or the RIS state associated with past communication via the RIS to that UE location.
An optional RIS beam search capability (RIS-BS) 1330 which may provide for local or global search through the states of an RIS for optimal communication with a UE (wherebyhe local states may be derived or retrieved from an RIS state topological map included in RIS metadata), or an adaptive beam steering capability which may adapt a beam from the BS 10 and/or adapt a state of the RIS and/or determine a beam angle based on measurements reports received from a UE 40 and/or the RIS (e.g. provided via connection between a RIS-UE 50 and a BS 10).

Moreover, the BS 10 comprises an RIS registration capability (RIS-REG) 140, also known as registration controller, including at least one of:
An optional RIS installation database querying (RIS-I-DB-Q) function 1410 that provides the ability to query an RIS installation database (RIS-I-DB) 30 to determine new entries in the RIS installation database 30 useable by the RIS controlling network or BS 10 to return means required for negotiating access to an RIS.
An optional RIS registration request response (RIS-REG-REQ-RES) function 1420 that provides the ability to respond to a communication from an RIS to set up the registration entry as part of the RIS registration process. This may as well be hosted in a network, e.g. the Internet, or a specific operators network in case the RIS is associated to a particular operator.
An RIS registration process capability (RIS-REG-P) 1430 that provides the ability to negotiate access to a RIS including at least one of negotiating a means of validation, getting control and query access, agreeing a price and pricing method (if any) and a means of getting access to the RIS metadata 220 and/or entering it into the RIS database 120.
An optional beam direction and/or UE location log (BD/UE LOG) 1440 which associates beam directions with the location (acquired during communication with the UE 10) of all UEs it has communicated with over some time period. This log 1440 can be analyzed using a beam direction and/or UE location log analysis to identify beam directions with a large variation in UE locations, consistent with an RIS being present in that beam direction. In an example, the locations of UEs may be estimated by the BS 10 for each UE while it communicates with it. In another example, a self-reported UE location may be refined by additional estimates performed by the BS.

Furthermore, the RIS 20 may comprise at least one of the following components or functions:
i. A reconfigurable surface (REC-SF) 270 which may be a multi-element electronically controllable surface which can be set to a number of configuration “states” each of which result in a different redirection pattern of radio waves of the frequencies associated with the communication. Such redirection could include at least one of:
reflection with a given reflection angle;
transmission;
focusing or defocusing;
generation of multiple beams;
refraction with a given refraction angle (this option can be important to allow for communications, e.g., within a building); and
absorption (this option can be used to reduce noise, and/or isolate a given environment).

A configuration state may be represented by a discrete number of state identifiers (e.g. state 1, state 2, state 3), or a collection of signal characteristics as a representation of the redirection pattern (e.g. (desired) reflection angle, focus point, number of beams, absorption/dampening factor, etc.)

The configuration state may also be the individual state of each element in a multi-element RIS which may be represented as a bitmap (e.g. identifying on/off state of each element) or a multi-dimensional array (e.g. identifying the phase shift, absorption, focus information, angle information, etc. of each element). Elements within a RIS may be electronically controllable (to change their individual state and/or desired properties), but may be also be physically controlled (e.g. by motors to physically control the angle of the RIS). For control of optical communication, the RIS may also have elements consisting of lenses of which the focus, opacity, curvature, polarization/filter state and reflection angles may be (individually) controlled.

These configuration states may be controllable by an access device (e.g. base station) of the wireless network by indicating the desired state, whereby the RIS reconfigures the elements of the RIS in such a way to achieve the desired state, or by sending control information with detailed (re-)configuration parameters (e.g. for each element in a multi-element RIS individually) from the access device to the RIS to reconfigure the RIS to its desired state.
ii. An RIS control module (RIS-CM) 260 configured to set the state of the reconfigurable surface 270 when commanded e.g. by the RIS communication module 110 of the BS 10. The RIS control module 260 may store a current state of the reconfigurable surface 270, that is currently set as RIS state. In addition, the RIS control module 260 may comprise an optional state cycling (ST-CYC) ability or function 2610 to perform state cycling on initial power-up, whereby it periodically switches its state to random widely differing states. This behavior may be suppressed when the RIS 20 is successfully registered with one or more networks and/or being controlled by an access device, or this function may continue to be carried out when the RIS 20 is not being commanded, in order to prevent the RIS 20 from being used as a passive surface by BSs. A goal may be to prevent others (e.g. BSs from network operators that do not have a usage agreement with the RIS owner) from using it as a passive surface. Another option is that the RIS 20 keeps changing states and only when the network decides, it configures its state according to the network's needs. Or, the network (e.g. BS 10) controlling the RIS 20 might know the schedule of the RIS states, e.g., the RIS 20 provides the BS 10 with its schedule for the period of time the BS 10 has rented the RIS 20, and use it to pick the right communication time slots to use the RIS when it is in particular desired states.
iii. RIS metadata (RIS-MD) 220, which includes information about the RIS (e.g. for deriving the capabilities of the RIS and its control by a network). This includes at least one of:
Identity information (e.g., this information may be entered by an installer).
Location and orientation (e.g., this information may be entered by an installer of the RIS 20 or RIS sensors (RIS-S) 250 that determine the location and 3D orientation and may automatically communicate it e.g. during a registration process);
A set of configuration states (e.g., a set of discrete or possibly continuous state values, which may be represented as the way that incident radio waves incoming on the surface at a specific angle are transformed into outgoing radio waves, including direction, focusing etc.; the states may be organized into a topological map (the RIS state topological map) showing which states are “adjacent”, i.e., give results, such as beam directions, which are the most similar, to enable performing a local search for an optimal communication path starting from a start RIS state);
A default RIS state (e.g., the default state of the surface (the state the RIS 20 sets itself to when there is no commanded state; the RIS 20 will probably default to a specific state either when unpowered or when not commanded to adopt some other state (these may not be the same); the network may need to know this default state, as it is likely to be in this state prior to the network commanding it to some state optimized for communication (unless the RIS 20 is set to perform “state cycling” to prevent its use as a passive surface, in which case it will have a random and changing state));
A speed of reconfiguration surface switching (the RISs may be able to switch their state as rapidly as possible, since slow switching would interfere with the ability of a BS to rapidly set up high bandwidth, reliable communications with a UE, in particular, a mobile UE, using that RIS and certainly to search for a communication path by cycling through the states of the RIS; the speed of state switching for the RIS 20 may indicate the number of states it is able to search through in a reasonable time if it is required to search for a communication path; or it may separately indicate a speed or time duration for being commanded from one state to another during operation);
Authentication, control and query methods (e.g., a control method by which a signal sent to the surfaces sets them to a specified state (which are one of a set of categorical values or a small number of continuous values); and/or an authentication method, by which a control signal sent to the RIS 20 can be determined to be sent by a valid originator; the authentication method may also ensure the freshness of the command; during the registration process some form of command validation may be established, for example security keys should be exchanged, so that the RIS 20 can in the future determine that any commands sent to it that it enacts actually originate from an authenticated source that has permission to command it; and/or a query method, by which a query signal sent to the RIS 20 can be determined to be sent by a valid originator);
A network control prioritization procedure (e.g., priority allocated to the control of the RIS according to the network operator, or BS identity, for example by configuring an ordered list of network operators identities/names (e.g. PLMN ID) or BS identities, whereby if the RIS receives a control command or a request to set up a control session by a network operator or BS that has higher priority (e.g. higher in the ordered list) than the network operator or BS currently controlling the RIS, the control command or request to set up a control session by the network operator or BS that has higher priority takes precedence. This may result in cancelling the control operation or terminating the control session by a network operator or BS that has lower priority, and/or may result in an error/notification message being transmitted to that network operator or BS that has lower priority. Additionally or alternatively, if the RIS has a choice of registering in an area covered by multiple network operators or BSs, it can register to the network operator or BS that is highest in the ordered list); and
Costs (e.g., if there is a cost associated with the control of the RIS 20 (that is charged by the owner of the RIS 20 to a network which controls the RIS 20), then this can be derived by the network e.g. both in terms of quantity and schedule (e.g., pay per use, fixed fee, time-of-day based pricing, etc.)).
Device Type (e.g. reflective RIS (which allows signals to be reflected to the UEs on the same side of the base station (BS)), transmissive RIS (which allows signals can penetrate the RIS to serve the UEs on the opposite side of the BS), or hybrid RIS (where the RISs have a dual function of reflection and transmission), which may also include information about e.g. number of individual sub-elements/panels, which materials used, physical dimensions/size of the device).
Capabilities (e.g. radio/communication capabilities, relay capabilities (e.g. support for/compatibility with JAB relay, smart repeater, ProSe relay), number/type of sensors, characteristics and (relative) positions of RIS elements, maximum/minimum reflection angles, supported and/or non-supported frequencies or frequency ranges, supported reflection angles, (number of) motors to physically control the angle of the RIS and/or elements of the RIS and the Degrees of Freedom they allow).

In addition, the RIS 20 comprises an RIS communication module (RIS-COM) 210 which can receive commands and queries and return results. The RIS communication module 210 may include at least one of:
An RIS Transmission and Reception system (RIS-TRX) 2110 which may use the same wireless communication system as the RIS-controlling network (e.g., BS 10), e.g., 5G NR but may include the sending and receiving of messages via other wireless communication systems or via the internet, connected locally using Wifi, Ethernet, Bluetooth or the like. In order to achieve seamless use of these RISs within the process of communicating with the UE 40, the state switching commands to be communicated with the RIS 20 may be transmitted or routed through the same communication network via which the BS is seeking to set up a communication path to the UE 40. However, other means of communicating with the RIS 20 (e.g., via an internet protocol, via a fixed internet link, Wifi, Bluetooth or the like) can be used, but may introduce a delay in the process of setting up communications with the UE 40.
An RIS registration capability (RIS-REG) 2130 configured to set up registration of the RIS 20 in the RIS installation database 30.
An RIS command/query validation and acceptance (RIS-CQ-V) capability 2120 which may including a validated network list (e.g., a list of networks or BSs which have been validated for control of that RIS 20), an optional RIS network priority list (giving e.g. the negotiated priority number of each validated network), an optional additional information needed for acceptance of a command/query from a network (such as a “Network Blacklist”), and an optional capability to initiate registration with one or more networks (e.g. RIS registration request capability). For example, using the RIS-CQ-V capability the RIS may be configured to attach and/or register to a network served by BS 10 (e.g. it may set perform an RRC Connection Setup procedure as specified in 3GPP TS 38.331 or a registration procedure as specified in 3GPP TS 23.502 to one or more of the networks/BSs discovered in vicinity (e.g. by receiving a respective System Information Block from a BS, announcing details of the BS and/or the network)), whereby the RIS may include an identity (and which may include other information such as metadata about the RIS) which the network/BS can use to authenticate the RIS, upon/after which the RIS may be registered in a core network function/BS and/or database (e.g. the RIS installation database 30, possibly in cooperation with the RIS-REG capability 2130).

Further, the RIS 20 comprises RIS current information data (RIS-CID) 230 that may include a current RIS state, which may indicate the configuration state currently set for the reconfigurable surface 270; an optional current controller priority number which is set to the priority number of a current controller (if not commanded, this flag may be set to zero (NULL)); an optional currently commanded flag indicating if the current state of the RIS 20/reconfigurable surface 270 is being currently commanded (e.g. by another network/BS); an optional time during period timer (e.g. a timer and timer value indicating for how long the current state has been commanded by a network); and that may include an out of operation flag (which is set to “False” if the RIS 20 is correctly powered and able to set its state to one commanded or to “True” if the RIS 20 is currently unable to set its state to a commanded one).

Optionally, the RIS 20 may comprise a network usage log (NU-LOG) 240 which stores a total time that each network/BS has used the RIS 20/reconfigurable intelligent surface 270 in the last time period and optionally a complete listing of times and lengths of usage of the RIS 20 for each network, during a defined time period.

As a further option, the RIS 20 may comprise RIS sensor(s) (RIS-S) 250, e.g., a set of sensors which collect the location and orientation of the reconfigurable surface 270. As an example, the RIS 20 may comprise of a GPS/GNSS module to determine its location and/or receive clock synchronization information, and may e.g. contain a gyroscope and/or compass to determine its orientation.

Optionally, the system may comprise a published RIS installation database (RIS-I-DB) 30 in which details of all RIS installations and a means of requesting registration for them are stored, whose functionalities include:
i. means/functions for entering new RIS installations into the RIS installation database 30; and
ii. means/functions for querying the RIS installation database 30 according to a location and/or according to an RIS type and/or according to RIS properties.

### RIS Registration and Control Procedures

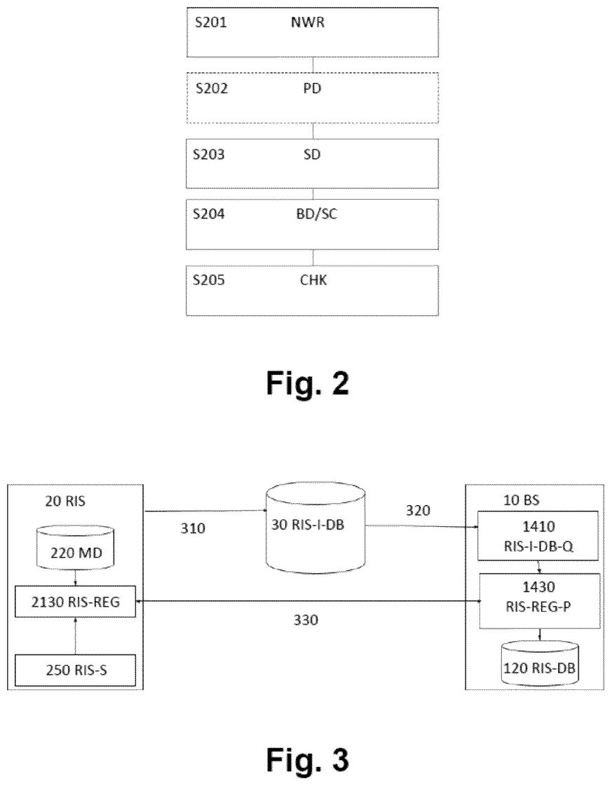

FIG. 2 schematically shows a flow diagram of an RIS registration and control method according to various embodiments.

In a network registration (NWR) step S201, the network (e.g., BS 10) registers the RIS 20 and determines all parameters needed for its control, while the control is performed by validated and accepted commands and queries.

In a subsequent path determination (PD) step S202, the network/BS determines an optimal communication path with a UE (e.g., UE 40), including directing the path of a beam-formed (directed) signal towards the RIS 20 and setting the RIS state so that the beam is correctly redirected towards the UE. Note that the network/BS may be triggered to communicate with the UE via a RIS and/or initiate a path determination step and/or configure/command a RIS, if the LOS signal between the access device and UE has deteriorated or experiences a drop (e.g. due to an obstacle) or has a peak in signal strength (e.g. due to a signal being reflected via a RIS). This may be discovered through measurement reports or CSI feedback from the UE. In a particular example, if the measurement reports show (e.g. through its RSRP feedback or UE RX-TX feedback) that the UE is moving in a certain direction, but adjusting the beam towards the UE does not improve or actually deteriorates the signal quality/strength, it may indicate that the UE is obscured by an obstacle. This may trigger the network/BS to trigger a local beam search or other communication/beam path establishment process (as described in further embodiments) to determine a RIS and/or a state of a RIS to set up a communication path to the UE via a RIS.

Additionally or alternatively, the network/BS may be triggered to communicate with the UE via a RIS and/or initiate a path determination step and/or configure/command a RIS, if it receives a message from/via a RIS that a UE has lost connection and/or may wish to communicate via a RIS, e.g. after receiving discovery messages over sidelink from the UE (as described in further embodiments).

In a following state determination (SD) step S203, the network/BS queries the RIS 20 to determine its current state, including whether it is commanded by another network and optionally, what the current commanded priority level is. Note that alternatively or additionally the RIS transmits information about its current state to the network/BS without being queried.

Then, in a beam directing and state commanding (BD/SC) step S204, if the path found in step S202 is a path which achieves good quality communication, and the network/BS is able to command/control the RIS 20, the network/BS directs its beam-formed (directed) signal towards the RIS 20 and commands the RIS 20 to the relevant state. This procedure may be repeated as the UE moves, or as large objects in the environment causing obstruction of RF communication path(s) move.

Finally, in a checking (CHK) step S205, the network/BS may routinely checkswhether the RISs in its RIS database 120 remain operational.

Hence, newly installed RIS systems can be registered such that the network/BS has an ability to command them to desired states, including discovery methods if a formal registration process for the RIS is not available. This provides an ability to rapidly plan communication paths which include relevant RIS systems, avoiding exhaustive real-world search through BS beam directions and RIS states. Moreover, a registered RIS that is no longer functional can be removed from possible communication path(s) with end users.

FIG. 3 schematically shows an RIS discovery and registration process according to an embodiment with RIS installation database 30 for RIS enabled communication, including required and optional subprocesses.

This process enables registration of a newly setup RIS 20 within a network and a validation of the network with the RIS 20, thereby establishing the properties of the RIS 20 with the network and enabling the network to validly command the state of that RIS 20.

An RIS installer may enter 310 a unique identifier of the RIS 20 (optionally along with a method of requesting registration) in the RIS installation database 30 or this may be performed automatically by the RIS 20 when switched on for the first time or triggered by a predetermined user-initiated or network-initiated trigger event (e.g. by the RIS attaching and/or registering to a network whereby the RIS may include an identity (and which may include other information such as metadata about the RIS) which the network/BS can use to authenticate the RIS and/or register its properties with a RIS installation database 30 or a network function/BS).

The BS 10, which is given access authorization e.g. by virtue of its operator's credentials, may periodically check 320 the RIS installation database 30 for new entries by using its RIS installation database querying function 1410. Alternatively, the BS 10 may be notified by the database 30 if a relevant new entry is added that matches a previous query by the BS.

The BS 10 may then use the database-entered method of requesting registration and/or its RIS registration process capability 1430 to obtain the RIS metadata 220 from the RIS 20 by using an RIS metadata negotiation and validation procedure 330 with the RIS registration function 2130. Although this process is shown as a direct procedure, it may also happen indirectly via a broker or service.

The details, including the RIS metadata 220, are entered into the RIS database 120 of the BS 10. If the RIS 20 contains RIS sensors 250, the location and/or orientation of the RIS 20 is collected from these sensors 250 and communicated to the BS 10 as part of the RIS metadata 220.

The BS 10 may negotiate the ability to control the RIS 20 using its RIS registration process capability 1430 to obtain data for validation, a priority for the RIS use and optionally a payment price and schedule for use of the RIS 20. Here, “negotiation” may not strictly include an individual price/access negotiation; it may be a simple request/response protocol, where the network requests access for a particular BS B1 (e.g., BS 10 of FIG. 3) to control a particular RIS RI (e.g., RIS 20 in FIG. 3), whereby the RIS installation database 30 may grant this access based on an existing bulk contract of the RIS owner with the network operator.

In other cases, a price negotiation process or other types of automated negotiation may be included.

Once successfully concluded, the command/query validation process can be agreed, which may, for example be that the public key (e.g., a Rivest-Shamir-Adleman (RSA) public key) is exchanged enabling the secure exchange of commands or responses. In an example, the security material may be obtained by the BS 10, so that it can later use this to authenticate to the RIS 20.

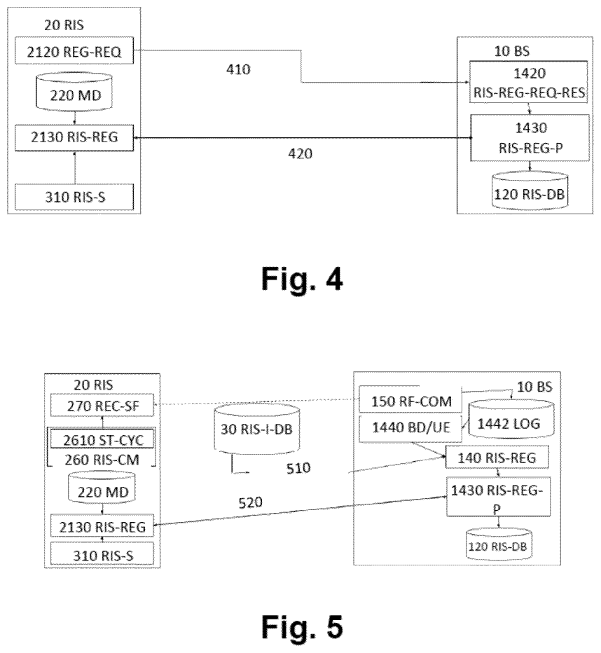

FIG. 4 schematically shows an RIS discovery and registration process according to an embodiment with RIS request for registration.

Following installation and on power-up, the RIS 20 is configured to use its RIS registration request (REG-REQ) capability of the RIS command/query validation and acceptance (RIS-CQ-V) capability 2120 to find local networks and request registration with those networks by securely transmitting 410 its RIS unique identifier and method of requesting registration to the RIS registration request response function (RIS-REG-REQ-RES) 1420 of the BS 10. This may be done directly, or indirectly. In the latter case, e.g. the RIS 20 may connect as a UE to a BS (e.g., gNB) and may then transmits its registration request to a network function or internet service, so that the BS 10 is a network service in this case.

The BS 10 negotiates 420 the ability to control the RIS 20 whereby it may use its RIS registration process capability (RIS-REG-P) 1430 to obtain validation, optionally a priority for the RIS 20 use and optionally a payment price and schedule for use of the RIS 20.

Once successfully concluded the validation process is agreed, which may, for example, include the exchange of a public/private RSA key for encryption/decryption of the commands/responses, or the exchange of a public key for authentication purposes. Alternatively, the BS 10 may have obtained previous validation/approval/authorization and/or may have obtained the credentials to authenticate itself with a RIS (e.g. through pre-configuration by AMF, or by receiving the credentials (e.g. from the AUSF after authentication) when the RIS registers itself to the network).

During the procedure, the BS may include the credentials for authentication (e.g. a public key) with the RIS. The RIS may use this to validate the BS, and the RIS metadata 220 may be supplied to the BS 10, which may be entered into its RIS database 120. Alternatively or additionally, the BS 10 may retrieve RIS metadata already present in the RIS database 120 or obtained RIS metadata via a core network function. If the RIS 20 contains RIS sensors (RIS-S) 310, the location and/or orientation of the RIS 20 may be collected from these sensors 310 and communicated as part of the RIS metadata 220.

In an embodiment that can be combined with any other embodiment or implemented independently, the RIS has a means for storing location information of one or more access devices, and may be able to receive such location information during initial configuration using an initial message exchange with an access device (e.g. during registration with the registration capability of the access device), or received through a configuration interface (e.g. Local UI, Configuration web page, NFC exchange with a mobile phone) during initial setup, wherein the RIS can be instructed/controlled (e.g. as part of initial setup, or according to a schedule) to a state in which it directs the reflection of the signal and/or beams in the direction of a location of an access device (in other words towards a predetermined fixed direction), whereby it may use such state as a default RIS state. The access device may use such state of the RIS to perform detection of the RIS and/or distance/angle measurement between the access device and the RIS (e.g. by measuring the timing between sending a signal and receiving the reflected signal and/or beams by the RIS and/or by measuring a time difference between antennas and/or signal characteristics (measured by multiple antennas of the access device)). Using such mechanism provides an efficient way to find and register a RIS for which its location is not (yet) known to the network/BS.

FIG. 5 schematically shows an RIS discovery and registration process according to an embodiment with autodiscovery of the RIS 20 in a locality method.

When the RIS 20 is installed and powered up but is not yet registered by any network, its initial behavior of the RIS control module (RIS-CM) 260 may be set to the state cycling (ST-CYC) function 2610 where the RIS 20 periodically changes its state to one selected at random between separated states.

In addition, owner(s) of the RIS 20 may set the RIS 20 to activate this state cycling function 2610 when not being controlled by a network/BS (rather than to a default RIS state) in order to (for example) prevent any networks from using the RIS 20 as a passive surface without appropriate payments or permissions, which might otherwise be possible if the state were predictable.

When the RIS 20 is registered and controlled by at least one network, the RIS 20 can adopt a state commanded by a registered network. The RIS 20 may also be operating the state cycling function 2610 whereby it is randomly changes its state when not being actively commanded to a state. In both cases a beam pointed at the RIS 20 from an unregistered BS will be redirected in different directions at different times.

A network (i.e., BS 10) with which the RIS 20 is not currently registered or which it is currently not actively commanding may note/determine, using its beam direction/UE location log (LOG) 1442 analyzed by its beam direction/UE location log analysis (BD/UE) 1440, that beam paths to certain end UE locations can vary significantly when the BS beam is pointed in a specific direction. That is, a certain beam direction is associated with a log of end user/UE locations which vary significantly at different times. Or, alternatively it may note that a BS beam pointed in a specific direction gives a particular variable (e.g. intermittent and periodic) connectivity to a particular stationary UE. This analysis may indicate that the RIS 20 is present in that beam direction. The corresponding information stored in the beam direction/UE location log 1442 may have been obtained from the RF communication capabilities (RF-COM) 150 based on a beam directed to the reconfigurable surface (REC-SF) 270 of the RIS 20 (e.g. based on a collection of measurement reports from UEs registered to the BS 10, which may include e.g. RSRP values per beam/SSB index). Based on this information/analysis the network (i.e. BS 10) may decide whether or not to register/connect with the RIS 20 and/or decide to transmit a command/query to the RIS 20.

Noting the location and/or beam direction of the newly identified RIS 20, the network can seek a means to establish registration with the RIS 20 by a wide variety of methods, including search in databases, sending a direct request using a wireless communication protocol (e.g. a discovery protocol), sending communications to the companies or individuals located in that building, and so on. In the example of FIG. 5, the RIS registration capability (RIS-REG) 140 of the BS 10 obtains 510 the unique identifier of the RIS 20 (and optionally the method of requesting registration) from the RIS installation database (RIS-I-DB) 30 based on e.g. a result of the beam direction/UE location log analysis 1440.

In an embodiment that can be combined with any other embodiment, once the RIS registration method has been obtained or a RIS 20 has registered to the network (e.g. using a built-in RIS UE 50), the RIS metadata 220 of the RIS 20 may be supplied to the BS 10 by using a negotiation and validation procedure 520 between the RIS registration process capability (RIS-REG-P) 1430 of the BS 10 and the RIS registration capability (RIS-REG) 2130 of the RIS 20. The RIS metadata 220 may then be entered into the RIS database 120 of the BS 10. If the RIS 20 comprises RIS sensors (RIS-S) 310, the location and/or orientation of the RIS 20 can be collected from these sensors 310 and communicated as part of the RIS metadata 220.

The BS 10 may negotiate the ability to control the RIS 20 using its RIS registration process capability 1430 to obtain validation, a priority for the RIS use and optionally a payment price and/or schedule for use of the RIS 20. Once this negotiation is successfully concluded, the command/query validation process is agreed as before. This is a validation process for subsequent commands or queries. Alternatively, the BS 10 may receive authorization information and/or instructions to control the RIS 20 from a core network function, such as AMF or from the AUSF (e.g. after a RIS has been authenticated when the RIS registers itself to the network). The information/instructions may include RIS metadata, a priority for the RIS 20 or a payment price or schedule for use of the RIS 20, credentials to use for communicating with the RIS 20, or other relevant information for transmitting commands or queries to the RIS 20.

In an embodiment that can be combined with any other embodiment, the BS might configure a RIS (or a smart repeater) with the capability of regular or event-driven notifications. This configuration might be done by means of an RRC message. This capability might allow or require a RIS to notify the BS when a given parameter, e.g., reaches a value, is out of range, etc. This capability might allow or require a RIS to notify the BS about a given set of parameters following a predefined schedule and using predefined resources (e.g., frequency or timing resources).

### Controlling the State of the RIS

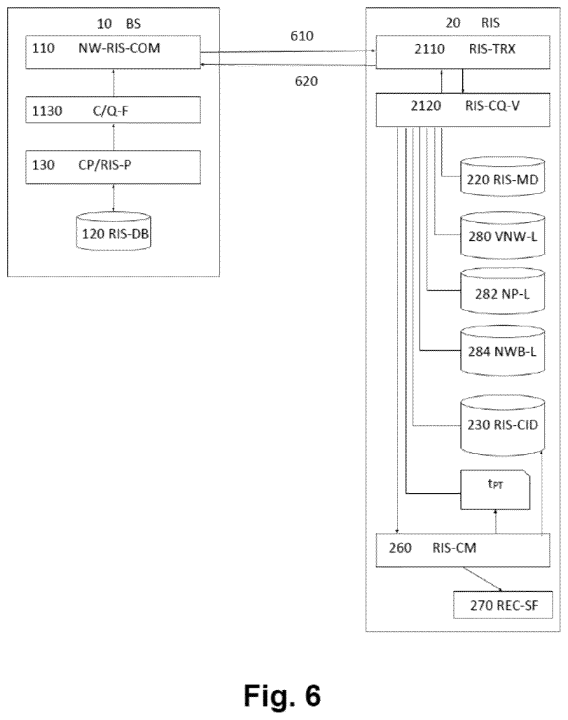

FIG. 6 schematically shows an RIS query and command process according to an embodiment, where a network (i.e., BS 10) seeks to command a specific RIS 20 to adopt a selected state. The process may involve the following subprocesses:

A communication route between the network to RIS communication system (NW-RIS-COM) of the BS 10 and the RIS transmission and reception system (RIS-TRX) 2110 of the RIS 20 is established by the communication path and RIS planning module (CP/RIS-P) 130, also known as the path establisher, of the BS 10 during registration, for example, a 5G communication for commands and queries 610 sent and responses 620 received between the BS 10 and the RIS 20. Note that the communication path may also be established under control/initiative of the RIS 20 using the same RIS communication system (NW-RIS-COM) and the RIS transmission and reception system (RIS-TRX). The RIS can use information (e.g. System Information Block, which includes the essential information for the RIS to be able to attach to the BS) broadcasted by a BS 10 and received by the RIS-TRX, after which the RIS may register with the network based on this broadcasted information. This information broadcasted by the BS may be seen as a command or query 610, and the attach/registration messages from the RIS may be seen as a response 620.

Then, a desired selected state of the RIS 20 may be determined by the BS 10, which may be checked by the network (e.g., the communication path and RIS planning module 130 of the BS 10) to determine that it is a permitted state in the metadata (RIS-MD) 220 of the RIS 20, e.g. by examining the RIS database (RIS-DB) 120. A command is then generated which may include an identity of the originating network/BS, an identity of the target RIS 20 or a temporary address currently associated with that RIS 20, validation data (so that the RIS 20 can check that the message is targeted to itself and that the sender is an authentic/authorized identity), and/or the query or command (which may include the state being commanded to and a time period required to be in that state, encoded in some suitable representation (e.g., one of a set of quantized time periods from a code book, such as bits indicating classes like ‘10 frames’, ‘20 frames’, ‘100 frames’ etc.)).

The BS 10 may then format the query/command using its command/query formatting for validation (C/Q-F) function 1130 into a form that will be successfully validated, for example it may encrypt it using an agreed key for that RIS. The command/query is then communicated to the RIS 20.

The RIS 20 then conducts the following processes:

The RIS 20 receives the communicated query or command 610 using a communication module of the RIS transmission and reception system 2110.

The RIS 20 checks the command/query for validity by its RIS command/query validation and acceptance (RIS-CQ-V) function 2120, for example by verifying a Message Integrity Code (MIC) using the agreed key related to that network and for acceptance. If accepted, the RIS 20 is set by the RIS command/query validation and acceptance function 2120 into the commanded state for at least the commanded length of time. Acceptance may be denied if
a. The command has an incorrect format or commands to an invalid state or the RIS identity provided does not match the identity of that RIS 20.
b. The command does not come from a valid source which may be stored in a validated network list (VNW-L) 280 of the RIS 20. Examples of invalid sources are a registered network operator or one of its base stations which cannot be correctly authenticated, or a source that can be authenticated but is not authorized to control the RIS 20. A valid source must have successfully completed the registration process.
c. The priority of the request is not higher than the priority of the current controller of the RIS 20 (if there is one).
d. Optionally, if the network is on a network blacklist (NWB-L) 284 stored in the RIS 20. A network may be blacklisted if for example there have been issues with the network, for example failure to pay its bills to the RIS owner and the RIS 20 has been set to deny commands from that network.
e. Some components of the RIS 20 are currently out of order.

If the RIS 20 has received a command and it is validated and accepted, then the RIS command/query validation and acceptance function 2120 controls the RIS control module (RIS-CM) 260 to set the reconfigurable surface (REC-SF) 270 of the RIS 20 to that state, updates the RIS current information data (RIS-CID) 230, and returns a confirmation to the BS 10.

If the RIS 20 receives a query (rather than a command), it returns at least one of the following information:
a. The current configuration state of the RIS 20 or a representation thereof. This may be a summary of the present state (e.g. a high-level state) without details about all actuators.
b. The currently commanded flag which may be set to “True” if the RIS 20 is currently being commanded to its current state and “False” if not.
c. Optionally, a priority order parameter (e.g., current controller priority number or indicator) which may be the position, on a stored command priority list (NP-L) 282, of the network that is currently commanding the RIS (only defined in case the currently commanded flag is “True”, else it may be NULL).
d. Optionally, a timer value t_{PT} to indicate to the network (i.e., BS 10) how long it has to wait before the network current commanded period ends.
e. If the reconfigurable surface 270 is out of operation for some reason, and the RIS 20 is aware of this, then it should return an out of operation flag set to “True” (otherwise “False”). It may optionally also return error bits or codes describing the problem in more details. Or, an indication of time when it expects to be back online, e.g., using t_{PT}.
f. (Subset of) Metadata 220 of the RIS 20 or updates thereof. This may include location information of the RIS or updates thereof if the RIS has moved.

If the RIS 20 does not receive any command, it may set the configuration state of its reconfigurable surface 270 to either a baseline state (e.g. default RIS state), or if the owner wishes to avoid the RIS 20 being used as a passive surface by unregistered, or non-paying networks, to perform state cycling.

### Prioritized Control Over a RIS

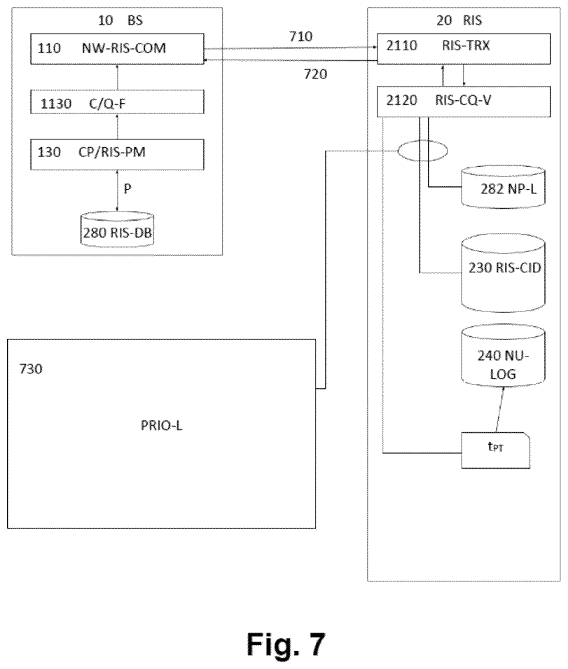

FIG. 7 schematically shows a network control prioritization process according to an embodiment.

An RIS 20 might have several networks as registered controllers. Therefore, a prioritization process may be used to ensure that there is not a deadlock or cycling of states when multiple networks wish to use the same RIS 20 in their communication paths.

During registration, a network (e.g., BS 10) can negotiate a priority for control of that RIS 20, with respect to other networks that also have negotiated for control. This may be a fixed number or may vary according to time of day and so forth or may be renegotiated at regular intervals or for specific events. Alternatively, instead of negotiation, the priority may be preconfigured as a policy in the RIS and e.g. stored by the RIS network priority list (NP-L) 282, The RIS may determine the priority based on command and/or query information received from the network (e.g. SIB information broadcasted by the BS or RRC message). For example, network A may be given a priority 1, network C a priority of 2 and network B a priority of 3. This means that networks B and C cannot command the RIS 20 when it is currently being commanded by network A. This priority number (P) can be stored by the BS 10 (e.g., by the communication path and RIS planning module (CP/RIS-PM) 130) in the RIS database (RIS-DB) 280 and by the RIS 20 in the RIS network priority list (NP-L) 282.

An example of a priority logic (PRIO-L) 730 for checking acceptance of a command or query 710 by the RIS command/query validation and acceptance (RIS-CQ-V) function 2120 of the RIS 20 may be as follows:

```
From network identity in command or query 710:
  Find a priority of the network in the RIS priority list 282: P1
From the RIS current information data (RIS-CID) 230:
  Find a current controller priority number: P2
If P2>P1:
  Acceptance = False
Else:
  If P2<P1 and time during period < minimum time
    Acceptance = False
  Else:
    Acceptance = True
```

Prior to commanding the RIS 20, the BS 10 can query 710 the current state of the reconfigurable surface of the RIS 20 by the network to RIS communication system (NW-RIS-COM) 110 and the command/query formatting for validation (C/Q-F) function 1130, which is returned 720 to the BS 10 by the RIS transmission and reception system (RIS-TRX) 2110, e.g., along with the state of the currently commanded flag and the priority number of the current controller.

If the BS 10 knows it has a higher priority number than the current controller of the reconfigurable surface of the RIS 20, and it requires a different state to that being used, and it cannot achieve good communication via a simple alternative route, then the BS 10 can command the RIS 20 to a different state. Optionally, this command may include an indicator for a desired period of time that the RIS should keep the state.

If the RIS 20 is not currently being commanded, then it accepts the next valid network command and enters that network's priority number (e.g., looked up from the RIS network priority list 282) into the current controller priority number and the currently commanded flag is set from “False” to “True”. Optionally, the time during period timer t_{PT} is set running (started).

At the end of the command time period, unless another command is received, the RIS 20 sets the current controller priority number to NULL and the currently commanded flag to “False”. Optionally, the value of the time during period timer t_{PT} may be added to the network usage log (NU-LOG) 240 along with the commanding network identity.

If the RIS 20 receives a command from another network while the currently commanded flag is set to “True”, the RIS command/query validation and acceptance function 2120 of the RIS 20 compares the priority number of the new command network with the value of the current controller priority number. If higher, then the RIS 20 ceases the previous command and sets it state to the new commanded state, the commanded flag remains set to “True”, and the current controller priority number is set to the new network's priority number. Optionally, the value of the time during period timer t_{PT} (plus the previous networks identity) is added to the network usage log 240 and the time during period timer is restarted.

In an alternative option, minimum time slots may be enabled, so that networks are not ‘thrown out’ in favor of a higher priority network until at least a minimum time has elapsed since the command was initiated.

As a further alternative option, if the RIS 20 is using a ‘pay per use’ scheme, a priority may be secured for the commanding network for a time period, e.g., by payment with a price related to that priority. That is, for a top priority slot, the network would need to pay a top priority price. The network could then determine how important the use of the RIS 20 is to a communication and select a priority level as appropriate. A BS 10 operated by the network may include the selected priority level in its commands/queries to the RIS.

In another embodiment, the BS may command the RIS with multiple priority levels.

A single network/BS may be authorized to use multiple priority levels. It may use different levels of priority depending on a specific command/scheduling request. For example, in case of emergency call, the highest priority level may be used and/or selected by the BS or RIS. The reason to use lower priority may be e.g. to save RIS costs, while in some cases the higher priority is really needed and the additional cost is accepted.

### Actively Searching for Communication Path Via RIS

Given the large search space introduced into the beam search by one or more RIS with possible option of communicating with a UE, traditional beam search techniques, expanded by commanding cycling though the states of the RIS, may introduce significant delays. Therefore, an improved beam path determination (e.g., BS beam direction and RIS state) for communication with a UE at a certain location is proposed. As mentioned earlier, a BS may be triggered to initiate a path determination, e.g. if the LOS signal between the access device and UE has deteriorated or experiences a drop (e.g. due to an obstacle) or has a peak in signal strength (e.g. due to a signal being reflected via a RIS). This may be discovered through measurement reports or CSI feedback from the UE. Additionally or alternatively, the network/BS may be triggered to initiate a path determination step, if it receives a message from/via a RIS that a UE has lost connection and/or may wish to communicate via a RIS, e.g. after receiving discovery messages over sidelink from the UE (as described in further embodiments).

The base station may perform a real-world active search for the best communication path to the UE, possibly by cycling through the states of the RIS (or the use of its elements one at a time) and beam directions, until it determines an RIS state which achieves communication which is good enough for its operative requirements. If the RIS has many possible states (or elements), this kind of search may not be fast enough for routinely establishing communication. Therefore, using this real-world search may be restricted to the first few times that the network uses an RIS, subsequently one of the other suggested processes would be used.

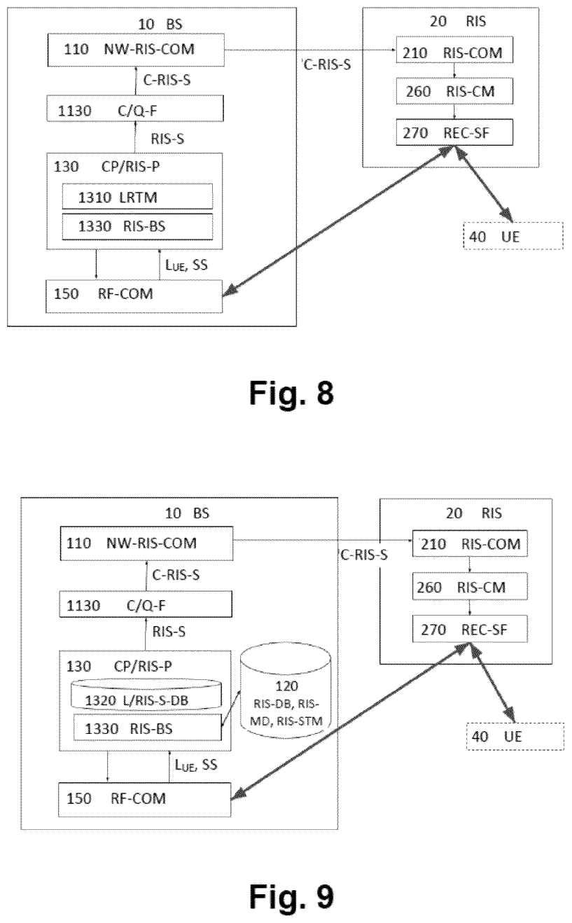

FIG. 8 schematically shows a communication path establishment process according to an embodiment with a real-world exhaustive search.

The proposed beam path establishment process enables the network to determine the location of a UE 40, to determine if an RIS inclusion is appropriate for communication with that UE 40, to determine which is the optimal state for the RIS to be set to in order to assist in that communication, and to determine the correct beamforming direction either directly to the UE 40, or to a passive surface that redirects to the UE 40 or to the RIS now set to the correct state to transmit/reflect the beam to the UE 40.

In an embodiment of FIG. 8, a transmission ray-traced modelling supported beam search is proposed.

The network (e.g., BS 10) maintains a 3D local radio transmission model (LRTM) 1310 of the environment, including the known RISs and the effects of their states, and performs a rapid simulated optimization process (e.g., by the communication path and RIS planning module (CP/RIS-P) 130) using this model to determine a correct beam direction and RIS state selection to achieve the best communication with a UE located at a specific location.

Once a suitable communication path has been found by the model, a small real-world local search can then be performed e.g. by the RIS beam search capability (RIS-BS) 1330 to optimize the link.

The communication path and RIS planning module 130 supplies a next RIS state (RIS-S) to the command/query formatting for validation (C/Q-F) function 1130 which generates a command (C-RIS-S) for the next RIS state and supplies it to the network to RIS communication system (NW-RIS-COM) 110. This command is then transmitted to the RIS 20 and received by the RIS communication module (RIS-COM) 210 which validates and forwards it to the RIS control module (RIS-CM) 260. The RIS control module 260 controls the state of the reconfigurable surface (REC-SF) 270 of the RIS 20 according to the received command, so that the reflection or refraction or redirection of the transmission beam from the BS 10 is modified accordingly.

The quality of the resulting communication paths as determined by a signal strength (SS) or another quality parameter obtained e.g. by the RF communication capability (RF-COM) 150 together with the location (L_{UE}) and/or measurement reports of the UE 40 may then be used to update the model. Additionally, or as an alternative embodiment of FIG. 8, the network selects a RIS state which enables a wide angle scattering of an incoming signal/beam and/or a wide beam (or even an omnidirectional signal) is propagated by the RIS towards UE 40. A UE 40 may receive such reflected signal and may perform measurements on the received reflected signal and report the measurements (directly through line-of-sight connection or through an indirect path via a RIS or other relay device) to the network/BS. The UE 40 may also report its estimated position (e.g. obtained through other means such as GPS, or TDOA measurements from nearby base stations). The RIS state selected by base station and commanded to the RIS may be selected in such a way to reduce the width of the propagated signal/beam and hence use a less wide beam towards the UE 40 and/or change the angle of the beam towards the UE, which may report its measurements again. By changing the angles and/or further narrowing the beam based on the feedback/measurements from the UE 40 using a feedback loop, a suitable communication path between the BS 10 and the UE 40 via the RIS 20 can be determined.

FIG. 9 schematically shows a communication path establishment process according to an embodiment with beam path memory and limited local beam search.

The communication path and RIS planning module (CP/RIS-P) 130 of the BS 10 can remember the path found for the UE 40 in the specific location (L_{UE}) and store it in a location/RIS state database (L/RIS-S-DB) 1320. This works similarly for the embodiment of FIG. 8 with the 3D local radio transmission model 1310.

If, in the past, this model has calculated a path and using this path by the BS 10 gave good results, it can be stored in the database 1320. Then, when a future UE is found near this location, the previous beam direction and state of the reconfigurable surface (REC-SF) 270 are retrieved and used, optionally with some further optimization (e.g., using local search in the RIS states) and updating of the parameters used to communicate to that location.

A limited search for optimal paths in the real-world is performed, having stored the results from past uses of the RIS 20, that is, the RIS states for communication with specific locations. From this start it can initiate a limited local search process through RIS states. Using the RIS state topological map (RIS-STM), the local search can be performed from the initial selected state.

Pilot uplink signals from the UE 40 may be used to determine its location (L_{UE}) within the space.

If beamforming in that direction directly (not via the RIS 20) is determined to be not good enough and a similar (but not necessarily identical) location has been served by the (nearby) RIS (e.g. RIS 20) in the past, the RIS state that was used for communicating with that location in the past is retrieved and the RIS state is set to that value, whilst beam forming at the RIS 20.

Using the RIS state topological map for that RIS, stored in its RIS metadata (RIS-MD) which may be stored in the RIS database (RIS-DB) 120, a local search through the adjacent states is performed as described in the embodiment of FIG. 8 and the signals quality is determined (e.g., based on the signal strength (SS) or another quality parameter).

When an adequate signal quality has been achieved (e.g., a predetermined threshold has been reached), the corresponding RIS state is used to communicate with the UE 40 and the RIS state and UE location (L_{UE}) may be stored in the location/RIS state database 1320 for that RIS 20.

### Failure Modes

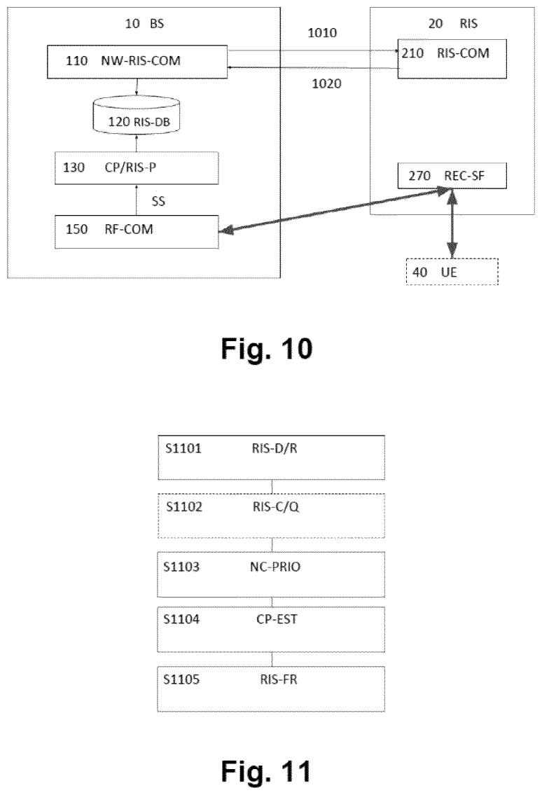

FIG. 10 schematically shows a failure recognition process according to an embodiment.

There will be situations where the RIS 20 has failed or is unpowered, has become obscured etc. and one or more network(s) and/or BS(s) need to recognize this situation and cease to use the RIS 20 in their communication paths. This could be a problem that impacts one network or one BS only. For example, a security key used by a particular BS may have expired. Or, the RIS 20 may have become obstructed due to recent building activities, but only for a couple of BSs, while other BSs can still use the RIS.

If the RIS 20 retains communication and control capabilities, but its reconfigurable surface (REC-SF) 270 is inoperative, then a query 1010 to the RIS 20 by the network to RIS communication system (NW-RIS-COM) 110 of the BS 10 can return a response 1020 with information about the RIS being inoperative or has issues to prevent proper use of the RIS (e.g. by setting an out of operation flag set to “True” in a response message), and the BS 10 can mark its RIS database (RIS-DB) 120 for that entry as inoperative so that it is not included in beam search procedures by the communication path and RIS planning module (CP/RIS-P) 130. Alternatively, the RIS 20 may itself try to connect to the network to send a message indicating that the RIS is inoperative or has issues to prevent proper use of the RIS.

If no response to the query 1010 to the RIS 20 is received from the RIS communication module (RIS-COM) 210, then the BS 10 may also mark its RIS database 120 for that entry as inoperative and therefore exclude it from the beam search procedures.

It is noted that the network may have a central RIS database (not shown), while at the same time each BS 10 may have a ‘subset’ RIS database 120 containing only the RISs that it can use.

If the RIS 20 correctly responds to queries and apparently to commands, but the RF communication capabilities (RF-COM) 150 of BS 10 measure a communication signal strength (SS) received from the UE 40, which remains unchanged when the RIS 20 is set to different states, then that RIS 20 is marked as inoperative in the RIS database 120.

RIS with Integrated UE

In an additional embodiment, the RIS may fully integrate communication capabilities, e.g., a UE that is able to communicate with the network and/or BS (e.g. using the usual RRC and NAS procedures as specified in TS 38.331 and TS 23.502 in case of a cellular 5G network) and, optionally, is able to measure the signal strength between itself and the end user UE using for example device-to-device (D2D) wireless communication. D2D communication is a communication between two mobile UEs without traversing the BS or core network. It may be non-transparent to the wireless network and can occur on the cellular frequencies (i.e., inband) or an unlicensed spectrum (i.e., outband).

For the registration process, the RIS with integrated UE can join a 5GS network in an automated manner, for example as an integrated access and backhaul (IAB) relay or as regular 5G NR UE, or as a narrowband Internet of Things (NB-IoT) UE. The RIS-UE may act as an JAB mobile terminal (IAB-MT). The IAB-MT may join a gNB as a usual UE and when the gNB and/or network determines that it is an JAB node, then the corresponding communication link can be established. In this case, RISs can join a gNB similar to a UE. In case of a joining as an JAB relay, the RIS UE may first connect with a gNB as the IAB-MT does. When the gNB detects the capabilities of the RIS UE, the gNB may acquire/register the RIS that will act as a distributed unit of the gNB. In the case of a RIS, all communication/control capabilities may be provided at the gNB. For instance, beam steering in an RIS may be done by sending a fixed beam towards the RIS and controlling the RIS states.

If the RIS has an integrated UE, then it is possible to find the position of the RIS, e.g., by using 5G localization/ranging services. It is also feasible to determine if there is line-of-sight (LoS) between gNB distributed units (DUs) and the RIS's UE, e.g., by analyzing the signal strength and delays of direct link and reflected/refracted/redirected links. If an LoS is found, it is also possible to estimate which area a given gNB DU might cover with the support of the RIS. This information may be stored in the RIS database and/or may be stored by a gNB CU and/or used to update the local radio transmission model.

Once registration on the network has been completed, and the RIS is able to provide its full RIS metadata to the network, the RIS may be entered into the RIS database and depending on implementation details either becomes a new RIS-DU under direct control of the gNB central unit (CU) in case the RIS implements an JAB node, or becomes anew RIS-UE which can be controlled by multiple networks. In the latter case, data access to this RIS may be provided by a single gNB (e.g., nearest, or highest-signal-quality gNB).

For the command/query process, the CU in the gNB can both query the RIS and command the RIS configuration via the UE in the RIS.

For the search for communication paths, if the RIS has a UE, then that UE can measure the signal strength of the beams of the gNB-DUs. This information can be used to determine which beams of which gNB DUs reach the RIS when set to a specific state, thereby delegating to the RIS the search for optimal final signal paths (that is, RIS states) from the RIS to the UE. Furthermore, a ranging/positioning procedure may be performed between a RIS-UE 50 and UE 40 (e.g. by sending signals to determine the round trip time, using known mechanism such as Fine Time Measurement defined in IEEE 802.11, or by measuring Time Differences Of Arrival (TDOA)) upon/after which a distance and/or an angle between the RIS-UE 50 and UE 40 may be determined. This information may be provided by the RIS-UE 50 or UE 40 to the network (e.g. BS 10) over the connection between the RIS-UE 50 or UE 40 and the network (e.g. BS 10), or may be indirectly obtained/calculated by a ranging service operated by the network based on UE measurements and/or intermediate results (e.g. calculated time differences or distances. The information about the distance and/or angle between the RIS-UE 50 and UE 40 may be used to determine the beam steering from a signal from the BS towards the RIS and how it should be propagated (e.g. which properties (such as redirection angle or focus point) a resulting beam between the RIS 20 and UE 40 should have), and hence which RIS state should be selected by the base station and commanded to the RIS.

### Flow Diagram for RIS Enabled Communication

FIG. 11 schematically shows a flow diagram of a process for an RIS enabled communication according to various embodiments.

The process is designed to enable the set up and command of RISs within a radio communication system such as 5G/5G-NR.

An initial RIS discovery and registration process (RIS-D/R) S1101 enables the registration of a newly setup RIS with a network and the validation of the network with the RIS, thereby establishing the properties of the RIS with the network and enabling the network to validly command the state of that RIS.

This may be achieved by an RIS installation database registration method where a new RIS looked up in a global RIS installation database and a registration method is retrieved (as explained in the embodiment of FIG. 3), or by an RIS request for registration method where the RIS sends communication to local networks when first switched on and sends the registration method (e.g. as explained in the embodiment of FIG. 4), or by a registration by autodiscovery of the RIS in a locality method where the BS notes local transmission paths with variable properties associated with an RIS and seeks registration through a variety of means (as explained for example in the embodiment of FIG. 5).

Then, in an RIS query and command process (RIS-Q/C) S1102, the network and/or BS specifies the command or query to be sent to the RIS using e.g. the RIS query and command capability, formats the command/query using e.g. the command/query formatting for validation function, transmits the command/query to the RIS using e.g. the network/BS to RIS transmission and reception system, and receives any response from the RIS using the network/BS to RIS transmission and reception system. Additionally, the RIS receives the communicated query or command using the RIS communication module, checks the command/query for validity and if the command/query is to be accepted using the RIS command/query validation and acceptance function, and if a command is accepted, the RIS command module sets the reconfigurable surface of the RIS to the commanded state, or if a query is accepted, the RIS returns the RIS current Information data including the RIS state.

In a network control prioritization process (NC-PRIO) S1103 during registration, with a subsequent change or dynamically with a command, the RIS stores the priority of a network that commands the RIS in the RIS network priority list.

If the RIS is not currently commanded and receives a command from a network, it determines that commanding network's priority and stores it as the current controller priority (e.g. indicated by a number as an index in an ordered list) in the RIS current information data, and then carries out the command.

If the RIS is currently commanded, it compares the priority of a new commanding network with the priority of the currently commanding network (stored as the current controller priority and if the new priority is higher, the RIS ceases the command from the previous network and allows the new network to command.

Alternatively, even low-priority networks may be given a minimum time period for their command, and the change in command is only enabled after this minimum command time has been reached.

In a communication path establishment process (CP-EST) S1104, the network and/or BS seeks to establish a communication path with a UE, where this path could include one or more RIS (where the RIS database indicates that that RIS is operative and that the network has command rights).

This may be achieved by an exhaustive search through beam forming directions and RIS states to find the best communication path to a UE, and when found, the BS directs its beam at the RIS and commands the RIS to the correct state.

Alternatively, as indicated in the embodiment of FIG. 8, a transmission ray-traced modelling supported beam search may be applied, where a transmission modelling within a local radio transmission model of the local environment is used to search for suitable beam paths (e.g., BS beam direction and RIS states), followed by a fine tune using local search in neighboring RIS states retrieved from an RIS state topological map. When found, the BS directs its beam at the RIS and commands the RIS to the correct state. Additionally or alternatively, the BS may use location information of the UE 40 (e.g. obtained from the UE or from a location service (e.g. Location Management Function as specified in TS 23.273) and similarly the location information from one or more RISs).

As a further alternative, as indicated in the embodiment of FIG. 9, results of previous beam direction plus RIS states and UE location are stored in a location/RIS state database. For a new UE location, the nearest entry for this location is searched in this database and if sufficiently close, the stored settings for BS beam direction and RIS state are used and fine-tuned with a local RIS state search. When found, the BS directs it beam at the RIS and commands the RIS to the correct state.

In another embodiment, AI models may be used for the communication path establishment process S1104 of FIG. 11, where it uses of an AI model for learning the relation or association between BS (gNB) beam settings and parameters, RIS states of nearby RISs and/or UE location(s) as input parameters and link quality and/or performance to UE(s) as output parameters.

This provides the advantage that an explicit (geometric) 3D model is not required and the impact of the built environment can be implicitly learned from interactions with RISs and measurements of resulting performance. The AI model could be operated in a network, or in a BS, and could be operated in conjunction with any model used in the other embodiments. In the latter model-based embodiments, a 3D model and/or beam path memory model may be initially used to make decisions, while the AI model learns the input/output relations. Once the AI model predictions are of sufficient quality, it can take over the decision-making automatically.

In an RIS failure recognition (RIS-FR) process S1105, as indicated in the embodiment of FIG. 10, the network and/or BS enters into its RIS database that an RIS is inoperative if the RIS returns an out of operation flag set to “True” or if the RIS returns no response to a query sent to the RIS or if communication signal strengths and/or other signal quality indicator(s) indicate no actual change in the RIS state.

### RIS Scheduling

In the following, further embodiments are described, which address at least one of the problems of scheduling/planning a request by a network and/or BS for a control over an RIS, intermittent power supply when RISs are deployed ubiquitously, adequately building a required RF propagation model, use of AI models to improve performance and keep it at a high level even while environmental/building conditions change, security/data protection of the query function against leakage of sensitive data about network operations, need for fast switching of RIS states, and need for concurrent operation of RIS for multiple operators.

In an embodiment, the RIS control module 260 of FIG. 1 may be extended with a scheduler to enable the use of scheduled RIS states. This implies that a network/BS that sends a command to the RIS can indicate a time period in the future for which it needs to set an RIS actuator for setting the state of the reconfigurable surface 270 to a particular state. The RIS control module 260 determines based on its schedule whether the requested command can be accepted, or not. One request by a network/BS may include multiple such scheduling requests.

In particular, when an RIS receives multiple requests for a same time period to set the RIS actuator to a particular single state, then all these requests can be accepted by the RIS without necessarily having to limit the control of the RIS to the highest-priority commanding network/BS.

Optionally, the RIS query response can be extended with one or more of the following information items:
a “time remaining in state” field that indicates for how long, or until what end time, the RIS remains occupied in the current commanded state. This enables the querying network/BS to schedule a time in the future when it can do another request to the RIS to command a particular RIS state. Or, it can immediately send a schedule message to schedule the RIS to change to that particular state in the future, at a time at or after the “time remaining in state” has passed.
a schedule information which may indicate which future time slots are already “booked” by other networks or BSs and are not available anymore for scheduling requests.
as a variation of above, the schedule may include a commanded priority information to indicate the priority of each scheduled time slot. If the commanding network/BS has higher-priority credentials, it may send a schedule request that supersedes the existing scheduled slots. Then, the original scheduling entities will be notified that their reservation has been superseded.

The RIS command can be extended with scheduling requests, e.g., a timeslot indication (in the future) when a particular RIS state is desired, and/or multiple scheduling requests can be conveyed in one message, optionally with multiple priority levels. (Pricing of RIS usage may depend on the requested priority level of a command or scheduling request.)

Furthermore, the scheduler can be extended to allow multiple networks/BSs to use the RIS simultaneously. This assumes that a RIS can act in such a way that incident signals do not interfere with each other, e.g., RIS acts as a mirror or RIS acts as a RF repeater (as described further below). Under this assumption, each network/BS may inform the RIS about a desired configuration state of the RIS for a number of time units (e.g., a frame, a subframe, a timeslot, an Orthogonal Frequency Division Multiplexing (OFDM) symbol etc.) and the RIS scheduler can then schedule the RIS state for the corresponding timeslots.

In an example with two BSs BS1 and BS2, the following scheduling may be applied:
BS1 might desire the following sequence of states: S1, S1, S1, S3, S3, S4, S4, S7.
BS2 might desire the following sequence of states: S1, S1, S2, S2, S3, S5, S5, S7.
Then, the RIS scheduler may schedule the following states: S1, S1, S1, S2, S2, S3, S3, S4, S4, S5, S5, S7 (the scheduled RIS states that are in bold characters are the ones that are shared by both networks.)

Sharing the RIS states between networks/BSs increases the income when renting an RIS. Furthermore, it reduces the overall latency. For instance, in the above example both networks/BSs (i.e., BS1, BS2) were able to use the RIS during 8 time units, while the overall communication took only 12 time units.

When the RIS scheduler has determined the schedule of the RIS states, the RIS controller (e.g., RIS control module (RIS-CM) 260) may inform the networks/BS when its desired RIS states are scheduled. For instance, in the context of above example, the RIS controller may send the following messages:
RIS to BS1: [1, 2, 3, 6, 7, 8, 9, 12]; and
RIS to BS2: [1, 2, 4, 5, 6, 10, 11, 12],
where the numbers in the message represent the time unit index associated to each of the requested timeslots. Here, the bold characters indicate those time slots that are used by both networks/BSs.

Note that upon reception of one of these messages, the network/BS might infer information about the state of the RIS in other times. For instance, since BS1 asked for 3×S1 and 2×S3 and those are allocated in time unit indexes [1,2,3] and [6,7], then the BS1 might guess that time unit indexes [4,5] are allocated to either S1 or S2 if the RIS cycles through the states sequentially. To avoid this, the RIS scheduler can apply a random permutation to the allocated states. For instance, the sequence of allocated states (resources) might be as follows:
S3, S4, S1, S7, S2, S2, S1, S3, S5, S1, S4, S5.
Then, the messages sent to the networks/BSs would be as follows:
RIS to BS1: [3, 7, 10, 1, 8, 2, 11, 4]
RIS to BS2: [3, 7, 5, 6, 1, 9, 12, 4]

In a further embodiment with intermittently powered RIS, some RISs may be embedded into the built environment or natural environment without having access to a reliable, wired, steady power source for operation of the RIS. Examples of such intermittently powered RISs may include RISs powered by solar power, RISs powered by harvested energy due to mechanical motion, vibration, wind, etc., or RISs powered by energy of impending RF waves (RF energy harvesting).

The advantage of such types of RISs is that barriers to widespread adoption are removed, i.e., there may be much more RISs integrated into the environment, even at places where normally no access to power/energy can be easily provided or where the cost of installation would otherwise be prohibitive.

To enable intermittently powered RISs, the following information can be added to RIS databases and/or may be provided by a RIS upon registration to the network (e.g. BS 10) and/or provided after being queried by the network (e.g. BS 10):
Intermittent availability information
   Example: a solar-powered RIS may be configured to register in a database its times of availability, e.g. based on estimated daytime period in its present location and in present season or weather forecast.
Power-on conditions information
   Example: an RF-energy-powered RIS may be configured to register during its initial registration that a controlling BS needs to send an RF beam to it in order to activate it. The controlling BS can look this up and/or perform the RF beam focusing to the RIS to power it prior to a query/command.
   Example: a wind-powered RIS may be configured to register itself as wind-powered, so that a controlling BS can use local/current weather predictions to make an initial estimate if that RIS would be available at a given time.
Reliability information
   Example: an RIS may be configured to advertise itself as “medium reliability” or “50% reliability” to indicate that it may not always be active. A Network/BS can use this information to make a selection out of multiple RISs. For non-time-critical information such as an IoT node UE reporting daily its status, which is however only reachable via a RIS, the BS can even retry the same RIS at a later time of the day if it finds that the current or target RIS is not powered or available at present.

In another embodiment, a tryout phase may be introduced after installation of a new RIS. There may be a limited time period of hours or days to enable nearby networks/BSs to try out the new RIS and record data about its properties, reachability and/or effect on network communication. This tryout period may be offered for free to network operators to stimulate adoption of the new RIS in the local communications infrastructure.

During the tryout phase, options as described in connection with the communication path establishment process S1104 of FIG. 11 may be executed, as well as the training of the artificial intelligence (AI) model mentioned in the embodiments related to FIG. 11.

### Concealing the RIS State

In another embodiment, the RIS state may be concealed to avoid information leakage. In any of the above embodiments, an authorized network/BS that is able to control a RIS is also able to query its current state. Providing such detailed state information may be undesired, as it could disclose information about how competing network operators use their RIS(s) for their purposes. This may happen unless the RIS is operating in the state cycling mode and the state is determined by the RIS at random.

According to the present embodiment, an RIS can provide specific “non-disclosed” state information values as a response to a query for the RIS state. Such state information values can be returned if the RIS is currently commanded by another operator/BS but the RIS does not want to disclose what the exact commanded state is.

One exemplary behavior of the RIS may be to respond to a network/BS querying a desired state, with a “matching” value or flag if the desired state equals the present state of the RIS. In other cases, the RIS may respond with a “non-matching” value or flag. As another option, the RIS may respond with a degree of matching, e.g., a value or flag that indicates “similar” or “same”/“different”, or a percentage of match (0-100%).

Providing such approximate values avoids disclosing the details of the RIS state information (which may consist e.g. of details of multiple actuators/array).

Combining RIS with Sidelink/Prose Relay

In another embodiment, the RIS-UE described above may be used but also act as a UE-to-Network Relay UE (e.g. as specified in 5G ProSe TS 23.304).

More specifically, in a 5G environment where the BS is called gNB, downlink (DL) signals from a gNB to an end-user UE may be propagated directly to the end-user UE via the RIS (reflection/refraction/redirection) at Layer-1 (i.e. PHY layer). Uplink (UL) signals from the end-user UE to the gNB may be propagated directly to the gNB via the RIS (reflection/refraction/redirection) at Layer-1 (i.e. PHY layer) if the RIS and/or the gNB determines that the signal quality/power is sufficiently high, without the RIS-UE interpreting and forwarding Layer-2 (e.g. MAC/PDCP) or Layer-3 communication (e.g. IP). Otherwise, if it is determined that the signal quality/power is not sufficient, the RIS may take a more active role and operate as Relay UE to actively relay the data on Layer-2 or Layer-3 from the end-user UE to the gNB. The gNB may send a command to switch between a relay mode via the RIS at Layer-1 and a UE-to-Network Relay mode on Layer-2 or Layer-3 based on measurement reports from the end-user UE and/or the RIS (which may also include measurements related to sidelink measurements between the RIS and the end-user UE).

In a slightly different embodiment, the RIS employs ProSe UE-to-Network relay functionality to actively forward the control plane data received from an end-user UE by the RIS-UE to the gNB, whereby after the gNB receives control plane data instructs the RIS (e.g. by sending a command to set a RIS state) and/or the end-user UE to communicate subsequent data/messages (e.g. user-plane data) via the RIS at Layer-1. The initial control plane messages transmitted/received via the ProSe UE-to-Network relay functionality may be used to exchange measurement reports (which may also include measurements related to sidelink measurements between the RIS and the end-user UE), location information and/or other information that may be used by the gNB to determine the RIS state to be commanded to the RIS for good communication with the end-user UE. In order for the end-user UE to be able to discover the features mentioned in the above two embodiments of combining a RIS with (a subset of) UE-to-Network relay functionality (e.g. to allow reflection of the signals between the gNB and the end-user UE at Layer-1), the RIS may be configured (e.g. through a policy provided by the core network) with a set of Relay Service Codes specifically for identifying that the combined functionality of RIS with (a subset of) UE-to-Network relay functionality. The RIS with (a subset of) UE-to-Network relay functionality may use the Relay Service Codes in its discovery messages exchanged with end-user UEs.

In an alternative embodiment, the gNB supports sidelink communication and the related protocols and uses the RIS to propagate sidelink messages from the gNB to the end-user UE and vice versa. This may include sidelink discovery messages that the end-user UE may use to discover a nearby RIS when the end-user UE gets out-of-coverage of the network. Note that during discovery via sidelink or by forwarding SIB information, the RIS may use a wide beam (or even an omnidirectional signal) to maximize the chance of UEs to be able to discover it. The RIS may be commanded by the gNB to a state in which the reflection pattern results in a wide beam or omnidirectional beam before it propagates such messages, or the RIS may determine that it should switch to such state based information about the message type being propagated (e.g. (e.g. recognized by the RIS itself and/or provided through a message type field in a DCI message or specific DCI message).

In another embodiment that can be combined with any other embodiment or can be implemented independently, the RIS may be commanded to direct a beam towards a particular end-user UE.

To achieve this, the gNB does not command the RIS to go to a particular state but commands the RIS to target a particular end-user UE of a list of known end-user UEs that is available to the RIS. During a procedure, possibly executed by the gNB (or location service or other core network service and transmitted via the gNB), the RIS may have been supplied with the list of end-user UEs to serve and optionally their estimated locations and/or angle between the RIS and the end-user UE (e.g. in relation to a reference line) and/or beam angle to use (e.g. in relation to a reference line).

After receiving a command from gNB (whereby the gNB providing the information about the end-user UEs (or the gNB forwarding the information from location service or other core network service) can also be seen as a command), the RIS may change its state (in particular the state of the reflective surface 270) so as to steer or focus the beam received from the gNB towards a particular end-user UE. This assumes that the RIS can collect the right information to be able to focus or steer the “reflected” beam on the particular end-user UE, as requested (in particular if the end-user UE is moving). If the RIS knows its own position (e.g. based on GPS module) and the position of the gNB and the position of the end-user UE it can calculate the angle to reflect/refract/redirect an incoming beam from the gNB towards the end-user UE, and modify its state accordingly. The gNB may provide the RIS with updates to the location information and/or angle between the RIS and the end-user and/or beam angle to use, if the end-user UE is moving, so that the RIS can update its state accordingly. Alternatively or additionally, if the RIS employs a RIS-UE 50 that supports sidelink, the RIS-UE 50 and the end-user UE 40 may perform ranging over sidelink (e.g. to calculate a distance and/or angle based on positioning reference signals transmitted over sidelink) and/or may perform other D2D measurements and/or LoS detection that the RIS may be doing with a particular end-user UE, e.g., using proximity services (ProSe) and/or vehicle to everything (V2X) sidelink (SL) communication. Based on this information, the RIS may determine the angle to reflect/refract/redirect an incoming beam from the gNB towards the end-user UE, and modify its state accordingly. The RIS may repeatedly perform such ranging/measurements over sidelink and modify its state accordingly when the end-user UE is moving.

V2X communication is communication between a vehicle and any entity that may affect, or may be affected by, the vehicle. It may use cellular networks and is then called cellular V2X (or C-V2X) to differentiate it from the WLAN-based V2X or other types. In 3GPP Release 15, the V2X functionalities are expanded to support 5G. C-V2X includes support of both direct communication between vehicles and traditional cellular-network based communication. The direct device-to-device (D2D) communication between vehicle and other devices (V2V, V21) uses a so-called PC5 interface. PC5 refers to a reference point where the UE directly communicates with another UE over a direct channel. In system architectural level, ProSe is a feature that specifies the architecture of the direct communication between UEs that are in mutual proximity. Sidelink/PC5 may also be used to determine distance and/or angle between two devices by using ranging (e.g. by calculating round-trip time measurements, fine-time measurements (FTM), measuring time difference of arrival (TDOA) over sidelink). In a particular embodiment, the RIS may receive a discovery message or connection setup request message via sidelink for an emergency call from a UE (e.g. by including a service identifier or relay service code specifically for this purpose in the message), upon which the RIS or gNB may determine the location of the UE (e.g. through ranging or by receiving information about the UE's location from the gNB or UE or a location service), and based on this location information determine the angle to reflect/refract/redirect an incoming beam from the gNB towards the end-user UE and modify its state accordingly.

Optionally, an RIS that has reliably determined the presence of an end-user UE in this way may report this to the database/gNB such that the gNB can make use of the RIS's ability to now focus the gNB's beam on this UE.

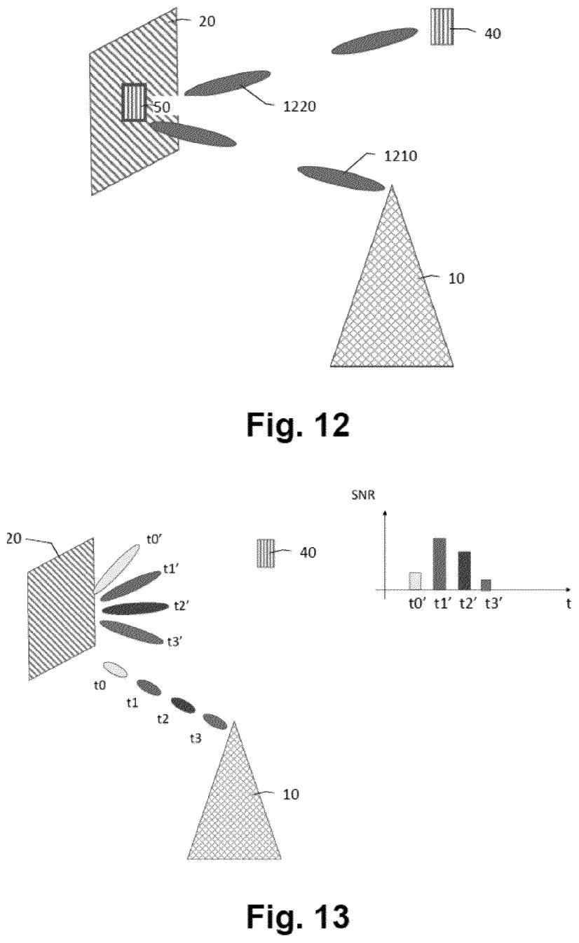

FIG. 12 schematically shows a first example of an improved beam steering process according to another embodiment.

In the first example, the RIS-UE 50 announces its RIS capabilities (e.g. using information provided through ProSe/sidelink Model A discovery) so that an UE 40 with bad connectivity can discover it. Alternatively, the UE 40 with bad connectivity can try to discover the RIS-UE 50 or other RIS-UEs (e.g. using information provided through ProSe/sidelink Model B discovery). Once the RIS-UE 50 and the UE 40 have found each other, if authorized, the RIS-UE 50 and the UE 40 may establish a communication link e.g. via a PC5 interface and they may also identify their specific direction (e.g. beam angle/path) by pairing their beams. The RIS-UE 50 can then send this information (i.e, the beam direction towards the UE 40) to a controlling gNB 10. The gNB 10 knows where the RIS 20 of the RIS-UE 50 is located and in which direction it has to form its beam to reach it. Furthermore, the gNB 10 also knows now the location of the UE 40 respect to the RIS-UE 50, since the RIS-UE 50 reported the beam direction from the RIS-UE 50 towards the UE 40. Thus, the gNB 10 can determine the configuration (e.g. reflection/refraction angle or redirected beam angle) of the RIS 20 to directly reach the UE 40. This is illustrated in FIG. 12 where the RIS configuration refers to a reflection/refraction/redirection angle as achieved e.g. by an orientation of the RIS 20 in space.

### Improved Beam Steering by RIS Providing SSBs and Synchronization and System Information

FIG. 13 schematically shows a second example of an improved beam steering process according to another embodiment.

In the second example, the gNB 10 sends system information (SI) towards the RIS 20, wherein the system information may be similar to synchronization signals of a physical broadcast channel (PBCH) used to broadcast basic system information within the cell of a cellular radio access network. The access device, the gNB in this case, directly from a CU or through a DU, drives the RIS in a way that the RIS seems to distribute its own synchronization signals. The system information can include a primary synchronization signal (PSS), a secondary synchronization signal (SSS), and a master information block (MIB) broadcasted in the PBCH channel. To emulate different synchronization signal bursts or blocks (SSBs) used in 5G and broadcasted in different directions through different beams, the gNB 10 sends such RIS SSBs towards the RIS 20.

For instance, in FIG. 13, the gNB 10 has send four RIS SSBs at times t0, t1, t2, and t3 towards the RIS 20 using a single beam pointing towards the RIS 20. The gNB 10 may change the RIS state in synchronism with the time that the RIS SSBs reach the RIS 20 in such a way that the RIS SSBs are reflected/refracted/redirected in different directions as illustrated in FIG. 13, where at time t0′ the RIS SSB is broadcasted using the highest beam direction, at time t1′ the RIS SSB is broadcasted using the second highest beam, at time t2′ the RIS SSB is broadcasted using the second lowest beam direction, and at time t3′ the RIS SSB is broadcasted using the lowest beam direction.

When the UE 40 receives the RIS SSBs, the UE measures the signal-to-noise ratio (SNR) as illustrated in the time-dependent diagram on the right side of FIG. 13. This diagrams shows that the first SSB broadcasted at time t0′ has been received with the second lowest SNR, the second SSB broadcasted at time t1′ has been received with the highest SNR, the third SSB broadcasted at time t2′ has been received with the second highest SNR, and the fourth SSB broadcasted at time t3′ has been received with the lowest SNR. The UE 40 can select the SSB with the highest SNR to establish a communication link with the gNB 10 through the RIS 20. This can be achieved by assigning an individual parameter (e.g., time or frequency or preamble or code) to each of the beams and using this parameter for designating a beam during the initial random access procedure.

In an example, the gNB 10 can keep sending RIS SSBs towards the RIS 20 and the gNB 10 can keep switching the RIS state accordingly to keep emulating the synchronization signals. If the UE 40 moves, the UE 40 can inform the gNB 10 about the received SNR for each of the RIS SSBs so that the gNB 10 can adjust the RIS state accordingly to ensure a good connection between the gNB 10 and the UE 40 through the RIS 20. Note that the UE 40 may be able to differentiate SSBs before being reflected/refracted/redirected (times t0, . . . ,t3 in FIG. 13) and after reflection/refraction/redirection (times t0′, . . . ,t3′) because the SSBs before reflection/refraction/redirection will lead to an almost identical (uniform) SNR while the SSBs after reflection/refraction/redirection will exhibit a non-uniform SNR distribution.

In general, it is proposed a method and apparatus which can be implemented in an access device such as a gNB 10, the method and apparatus being for controlling the distribution of system information, e.g., synchronization signals, a MIB, or a SIB1, through a reconfigurable relay device 20 by (1) optionally, estimating the propagation time between the access device and relay device or configuring it based on the location of access device and relay device, (2) providing a relay device with a beam related configuration, e.g. on the timing or signal strength, or direction of beam, e.g., for the distribution or rebroadcast of system information, and (3) regularly sending at least one set of system information towards the relay device such that when received by the relay device, each set of system information is rebroadcasted or reflected/refracted by the relay device using a different beam configuration, where the system information may be related to a Physical Cell Identity (PCI)/Global Cell Identity (CGI) different than the PCI/CGI of the gNB or the SSB indexes assigned to the relay are different than the SSB indexes used by the gNB.

In a further embodiment that can be combined with any other embodiment, or that can be implemented independently, the system information associated to the RIS 20 (which may be reflected or (re-)broadcasted by the RIS 20), e.g., MIB or system information block (SIB1), may include information about the fact that the gNB 10 is transmitting this signal via the RIS 20. This can be, e.g., a single bit that can be either 0 or 1. The system information associated to the RIS 20 may also include information about the parent gNB 10 steering the RIS 20, e.g., it can include the physical cell identity (PCI) or Global Cell Identity (GCI) of the parent node. Furthermore, the system information may include information about the RIS 20, such as its identity or its location or other meta-information about the RIS, and/or information about the home network operator (PLMN ID) of the RIS. Such information can be used by the UE 40 to decide about joining/communicating through the RIS 20 or not, and/or may be used by the UE 40 to Identify which RIS was used by the access device and find the corresponding stored (meta-)information of the respective RIS, and/or which may be used by the UE 40 to further adjust its RF signals, in order to optimize the communication with the access device via the respective RIS. Note that for forwarding SIB information, the RIS may use a wide beam (or even an omnidirectional signal) to maximize the chance of UEs to be able to discover it. The RIS may be commanded by the gNB to a state in which the reflection pattern results in a wide beam or omnidirectional beam before it propagates such messages, or the RIS may determine that it should switch to such state based information about the message type being propagated (e.g. recognized by the RIS itself and/or provided through a message type field in a DCI message or specific DCI message).

In another embodiment, random access channel (RACH) enhancement can be achieved by coordinating a gNB with an RIS in such a way that the RIS broadcasts system Information. As in 5G, the RIS' SIB1 can include configuration parameters for operating the RACH. These parameters tell the UE which parameter (e.g., frequency or timing or preamble or code) it should use to connect to the gNB through a given RIS beam. This requires the gNB to configure the RIS during those RACH timeslots in such a way that a physical RACH (PRACH) sent by the UE towards the RIS is directed (reflected/refracted/redirected) towards the gNB. Since a RIS might only be able to reflect/refract/redirect the communication, the gNB might assign access slots for different RIS beams that have different timings.

In general, it is proposed a method and apparatus which can be implemented in an access device such as a gNB 10, the method and apparatus being for controlling the random-access of a device 40 through a configurable relay device 20 by (1) optionally, estimating the propagation time between the access device and relay device or configuring it based on the location of access device and relay device, (2) providing a relay device with a configuration on the timing of beam directivity, e.g., for the monitoring of PRACH preamble messages, in different directions around the relay device, and (3) adjusting its beam directivity according to the provided configuration to monitor the PRACH preamble messages received from different directions at different times.

Improving CSI and Reducing Interference when Using a RIS

In another embodiment, a channel state information (CSI) can be enhanced. In wireless communications, the CSI refers to known channel properties of a communication link. The CSI describes how a signal propagates from a transmitter to a receiver and represents the combined effect of, for example, scattering, fading, and power decay with distance, as obtained e.g. by a channel estimation process. The CSI makes it possible to adapt transmissions to current channel conditions, which is crucial for achieving reliable communication with high data rates e.g. in multiantenna systems.

Thus, CSI reference signals (CSI-RSs) may be used when the gNB transmits towards the UE to understand the channel properties and how good (or bad) the communication link is. The gNB may send CSI-RS and the UE receives these and reports their value. In an example, a CSI-RS may be sent every two resource block(s) (SSBs). The CSI-RS may be periodic, semipersistent or aperiodic (e.g., transmitted in a downlink control information (DCI) message).

In an example, zero-power CSI-RSs may be provided as time/frequency slots where the gNB informs the UE that nothing is transmitted. These slots can be used by the UE for interference management. Based on the received signals, the UE may select a most suitable precoding matrix for antenna steering for the gNB, e.g., by using given a codebook of precoding matrices. There may be two types of codebooks: type 1 is coarser (e.g. for single users) and type 2 is extensive (e.g. for multi-user multiple-input-multiple-output (MU-MIMO) systems). In the uplink direction, CSI may not be required, since the gNB can track the quality of the received signal and instruct the UE accordingly.

As an alternative option, sounding reference signals (SRSs) may be used in the present embodiment, instead of the CSI-RSs. SRSs are reference signals transmitted by the UE in the uplink direction and are used by the gNB to estimate the uplink channel quality over a wider bandwidth e.g. for scheduling purposes.

In the case of an RIS, the gNB may be interested in knowing the channel to the UE through the RIS.

In an example, an increased number of timeslots, e.g., n, may be allocated to transmit the CSI-RS when a UE connects through the RIS. For instance, n=3 slots. Although the reference signal may be identical at the transmission time for all n slots, the gNB may control the RIS in such a way that the RIS has slightly different reflection/refraction/redirection RIS coefficients in those n slots. For instance, for n=3, the first slot might use the reflection/refraction/redirection RIS coefficients and gNB-RIS beamforming that are currently considered as optimal, and for the other two slots slightly different reflection/refraction/redirection RIS coefficients and/or gNB-RIS beamforming may be used. The aim may be that the UE can help the gNB to identify in which direction (i.e., which reflection/refraction/redirection RIS coefficients) the RIS should be steered in order to keep a good connection and/or how the gNB beam should be steered towards the RIS.

The above procedure can be done for each resource block, or the configuration of beam/RIS might be slightly adapted for CSI-RSs transmitted in different resource blocks.

In a further embodiment, the RIS may be used for multi-BS signal interference avoidance. If two BSs are each communicating with a different UE on the same frequency, and the BS signal paths to the two UEs overlap, there is a potential for interference. This may be avoided if one (or both) BS use a path via one or more RISs instead.

Therefore, in this embodiment, a node (e.g., a high level node which controls several local BSs) representing a group of linked BSs seeking to communicate with several UEs can be used to provide a cooperative communication path planning algorithm which additionally checks for potential path interference in the operation of different BSs and selects a path via an RIS if doing so reduces the interference between the respective BSs communication with respective UEs.

In another embodiment, interference coordination/mitigation may be achieved by reusing the RIS by multiple base stations (gNBs). In particular, in order to avoid two access devices causing interference by operating one or more RIS elements simultaneously with the same/similar frequency, the RIS may inform one or more of the access devices of the frequency and/or schedule being used/requested/operated by one or more other access devices, e.g. by using the RIS communication module 210 (for example by using the query/control communication protocol or by sending a notification/measurement). The RIS may be equipped with one or more sensors to detect interference. If interference is detected, this may be reported to one or more of the access devices, or the RIS may change its state or stop its operation. The RIS may use measurement information from one or more sensors and/or its built-in UE capabilities to identify the access devices from which the signals originate and/or to calculate the angle of arrival of the signal(s) causing interference and report this information to the one or more access devices. Also RF measurement information may be reported, to the one or more access devices such as channel state information, signal strength, frequency information and other information about the received signals such as timing advance information.

When a gNB uses the RIS, its range may be extended leading to a potential interference in another area. The gNB may inform a second gNB about its wish to use the RIS including the desired area of coverage, frequency and/or timing. This can be done e.g. through the Xn control plane interface between gNBs as defined by 3GPP. The second gNB can confirm/deny this usage. The Xn interface may also be used to synchronize the clocks of the two gNBs and/or to align their schedules to use the RIS.

A UE connected to the second gNB may measure a given interference level caused by the RIS that is currently controlled by a first gNB. The UE can inform the second gNB about the interference level, and the origin. The origin can be indicated if the gNB sends a CSI-RS linked to the RIS with its identifier. The second gNB can then use the Xn control plane interface to inform the first gNB.

A random changing state of a RIS is beneficial to prevent attackers from extracting or sensing information about the environment where the network is deployed, e.g., extracting information about the number of users, their activity or even their vital signs. The reason is that along with Orthogonal Frequency-Division Multiplexing (OFDM), MIMO can provide Channel State Information (CSI) for each transmit and receive antenna pair at each carrier frequency. CSI measurements, e.g., from WiFi systems can be used for different sensing purposes. For instance, WiFi sensing reuses the infrastructure that is used for wireless communication, so it is easy to deploy and has low cost. Moreover, unlike sensor-based and video-based solutions, WiFi sensing is not intrusive or sensitive to lighting conditions. In 5G, the Channel State Information Reference Signal (CSI-RS) is a downlink signal that is configured per device and received by the UE and used by the UE to estimate the channel and report channel quality information and/or interference measurements back to the gNB. In particular, the report might include Channel Quality Indicator (CQI), Precoding Type Indicator (PTI), Precoding Matrix Indicator (PMI), Rank Indicator (RI) or Layer Indicator (LI). In 4G, in contrast to CSI-RS, the Cell Specific Reference signal (CRS) was specific to the cell. The base station can perform communication/sensing functionalities, e.g., scheduling related processing, based on the reported CSI. The CSI-RS is configured specific to UE, but multiple UEs can also share the same resource. Such CSI-RS might be used for beam management, connected mode mobility, radio link failure detection, beam failure detection, coordination and multipoint transmission, or sensing, also in 5G.

An issue regarding sensing is if an attacker senses the environment and passively extracts information about the environment from the CSI measurements.

Another issue is how the communication system (e.g., the device 40 or base station 10) can properly measure the CSI if RIS in its environment keep changing its reflection/refraction/redirection properties.

Another issue is how the CSI between RIS 20 and device 40 can be obtained.

To deal with these issues, it is advantageous that (1) devices or users who have registered with the network and are authorized, can perform suitable CSI measurements, e.g., for sensing, by using the Channel State Information RS distributed from the network/BS but (2) devices/users that are not authorized cannot.

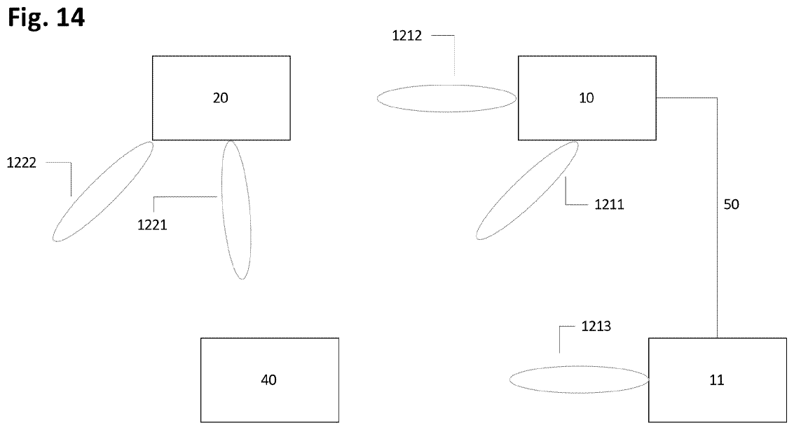

To this end and referring to FIG. 14, a registered device 40 is provided with the schedule of the RIS 20, e.g., if the device 40 has to locally estimate the CSI parameters, e.g., to perform sensing activities. In particular, a device 20 that has joined the communication system might receive the current or future RIS state by means of a confidentiality and/or integrity protected RRC message from the base station/network 10. The base station/network 10 might also provide the device with its own beam forming configuration (1211, 1212), e.g., whether/how the base station/network is targeting its beam 1211 directly to the device 40 or its beam 1212 to the device 40 through the RIS. The RIS 20 might reflect/refract/redirect beam 1212 in different ways depending on its schedule, e.g, 1222 or 1221. The RIS 20 might also monitor (e.g., by means of the RIS UE) the CSI between RIS 20 and base station/network 10, and report it to the base station/network 10. The base station/network might share this information reported by the RIS 10 with the device 40. Given the received information, the device 40 can compute the channel state between (1) base station 10 and RIS 20 and between (2) base station 40 and device 10 through the RIS 20. If the network/BS 10 is in charge of gathering CSI reports, e.g., to perform sensing activities, the network/base station 10 might not only require the CSI measurements taken by the device 40, but it might also require CSI measurements of the RIS 20. Since multiple devices 40 might connect through a same RIS 20, the RIS might not require reporting the CSI measurements related to all CSI-RS associated to all connected devices, but only to a subset of them. The base station/network 10 might indicate to the RIS 20 which CSI measurements on which CSI-RS are required, or alternatively, the RIS might indicate which CSI measurements it has performed on which CSI-RS. Since the base station/network can configure both the UE and RIS, the base station/network can configure them to report the measured CSI values using resource elements that are close time wise. Given these two sets of CSI measurements, the base station/network can estimate the CSI between UE 40 and RIS 20, e.g., it might be able to discern where the channel conditions are worse/better, in the link between base station and RIS or in the link between RIS and UE. Simultaneously, if the RIS 20 state keeps changing, the reported CSI might deliver less information to an eavesdropper and protect in this way the privacy of the users. It is worth nothing that the CSI measurements could also be encrypted to prevent a passive attacker from eavesdropping on the measured CSI values and extracting sensing information. Encryption might be done by the UE by generating a pseudo-random sequence by means of a key derivation function or a block cipher or a stream cipher and xoring the CSI values with the pseudorandom function. The key used for encryption might be derived from K_gNB. The base station/network can recover the values by performing the inverse operation. Furthermore, the base station/network might need the associated RIS states of surrounding RIS 20 when the CSI measurements were obtained. If the UE 40 is connected to a second base station 10, the second base station 10 already knows the RIS state since it is determined by the second base station itself If the UE 40 is connected to a first base station 11, then the first base station 11 should receive the RIS schedule from the second base station 10, e.g., through a communication interface 50, e.g., the Xn interface. In this setup, a device 40 that has properly joined the communication system can make use of CSI measurements, e.g., for sensing. However, devices that are not authorized cannot make use of the CSI measurements to passively monitor the environment because of the random looking schedule of the RIS that introduces randomness in the estimated channel. It is to be noted that the reflecting device 20 might also be a smart repeater. The RIS 20 can be commanded to provide its configuration, and this configuration can be shared with a device 40 or another base station/network 10 for channel state assessment. The RIS 20 can monitor the CSI-RS and measure the parameters (e.g., CSI related) assigned to at least a device 40 connected to the base station/network through the RIS 20, and the RIS can provide the base station/network with its measurements of the CSI-RS so that the base station/network can steer the communication/sensing functionalities based on the received measurements.

In another embodiment, a safer way for RIS random state cycling is provided. As proposed above, the states of the RIS may randomly change to prevent users from using the RIS without paying. However, this does not prevent an attacker from using it to cause randomized interferences in the environment by pointing a malicious beam against the RIS.

This problem can be solved by configuring the RIS to redirect incident waves or beams, independently of the incident direction, towards a direction where they do not cause damage/interference, e.g., the basement of building, or by configuring the RIS as metamaterial absorber.

Another consideration refers to the fact that in above embodiments a gNB is capable of using an RIS to communicate with a UE at a time. However, existing gNBs are able of MIMO operation by using multiple beams. In some scenarios it is desired to control an RIS capable of handling multiple beams simultaneously. In an embodiment, this can be done when the RIS behaves differently depending on the properties of the incident electromagnetic (EM) wave, e.g., depending on the frequency, polarization, etc. For such an RIS, it is possible for the gNB to control the RIS so that the reflection/refraction/redirection angle depends on the EM properties of the incident wave so that the gNB can communicate with two different UEs simultaneously through the same RIS. The procedure may be as follows: 1) the gNB sets the RIS at a given state at a given period of time, the state referring to refraction/reflection/redirection properties that depend on certain properties of the incident EM wave (e.g., frequency, polarization, etc); 2) the gNB transmits two or more beams towards the RIS, each of the beams featured by specific properties (e.g., frequency, polarization, etc) that are handled differently by the current RIS state so that the beams are split at the RIS. In this procedure, the RIS state is such that the gNB will reach two or more UEs, at different locations, simultaneously, when sending two or more beams towards the RIS since the two or more beams sent from the gNB to the UEs through the RIS will be reflected/refracted/redirected differently by the RIS. Similar behavior is applicable to a smart repeater.

Timing Synchronization when Using RIS

In another embodiment in relation to earlier embodiments and figures on controlling the RIS and/or communicating via the RIS, the RIS switching time (latency) may be taken into account. As described earlier, the gNB may send a command to the RIS to set it in a given configuration and may then send the corresponding data to be reflected/refracted/redirected by the RIS towards a target UE.

This procedure involves a certain latency which depends on the time required by the control message (command) to reach the RIS, plus the time required by the RIS to change its state in response to the control message (command). An estimation of this latency depends on the questions whether the RIS operates in accordance with a clock and whether it is synchronized with the gNB.

The gNB may be configured with the switching time of the RIS. The switching time of the RIS is thus a parameter that may be sent to the gNB or retrieved from a configuration database, or from RIS metadata.

The propagation delay between the gNB and the RIS is also a parameter that can be learned or configured, in particular, if the RIS does not have a clock or the RIS is not synchronized with the gNB. This parameter may be related to a time of advance associated to the RIS-UE connection and can be derived from it. Once the gNB knows it, the gNB can send user plane messages early enough to achieve a desired timing of the RIS states that have been configured by means of control messages. For instance, the gNB may send control messages (e.g., DCI messages) indicating the requested RIS states and shortly afterwards send the user plane messages for the UE.

In an example, the RIS may be equipped with a clock which is synchronized with the clock of the gNB. If this is done, then the gNB can schedule some given states at some given timing resources, e.g., a subframe, a timeslot, etc. If the RIS has a clock and the clock is synchronized, the gNB can send scheduling requests in advance and only needs to focus on the sending time of the user plane messages so that they arrive at the RIS when it is at a given state.

In an example, the RIS may be equipped with a clock which is synchronized with the clock of the gNB except a fixed time of advanced (ToA), i.e., the clock of the RIS equals the timing of the clock of the gNB plus ToA. The ToA equals the distance between gNB and RIS times the speed of light. This ensures that uplink transmissions will arrive simultaneously at the gNB independently whether they are sent directly to the gNB or through the RIS.

In case the RIS serves multiple gNBs, it may remain clock-synchronized to multiple (N) gNBs at the same time, for example up to N=2 or N=4. Then, when it receives e.g. instructions/reservations from a first gNB it applies the instructions/reservations relative to the synchronized clock of the first gNB and similar for other gNBs.

In another embodiment, a timing advance adjustment may be applied. Timing advance is a special command (notification) in LTE and 5G NR that enables a UE to adjust its uplink transmission (e.g., physical uplink shared channel (PUSCH), physical uplink control channel PUCCH, SRS etc.), so that messages transmitted by multiple UEs reach the gNB in a synchronized way, i.e., without mutually interfering at symbol/slot boundaries.

A gNB that is receiving an uplink transmission from a UE directly in LoS and needs to switch to a new configuration where this transmission is received via an RIS, can configure a lower timing advance value to compensate for the longer transmission path length via the RIS in case this indirect path length is substantially longer than the LoS path. Vice versa, when switching from an RIS path to a direct/LoS path, the timing advance value can be increased again.

The timing advance value may be communicated during random access via the RACH channel. In particular, the UE may extract the timing advance value from the RACH response. The timing advance field in this RACH response message or any other suitable response message may be 12 bits long. Afterwards, the UE can adjust it e.g. via a timing advance control element (CE) of the Media Access Control (MAC) protocol, where the timing advance CE field is 6 bits long. If an RIS (or smart repeater) acts as a simple RF repeater, the UE might consider that the gNB and the RIS have the same timing advance, since there is a single PCI/CGI and, e.g., the ServingCellConfigCommon structure has a single field for the timing advance. This can lead to a non-optimal performance and can be improved by having two or more timing advance values, each of them linked to one or more beams in the cell.

An alternative option to minimize changes is that a gNB steers an RIS to act as a standalone gNB DU with its own PCI/CGI. In this way, a UE would perceive two different DUs and can apply different timing advance values to each of them. The timing advance values applied to UEs connected to an RIS may be smaller than they should actually be if the RIS were an actual gNB, similar to the embodiment of FIG. 13. The reason is that the timing advance value depends on the distances between the UE and the RIS and between the RIS and the gNB, while if the RIS were a gNB, the timing advance would only depend on the distance between the UE and the RIS.

The fact that the timing advance of the gNB and the RIS are related can also be used to better configure this value for both gNB and RIS since the gNB knows that the distance between the gNB and the UE over the RIS is always greater than the distance between the gNB and the UE. The gNB may also know that if the distance between the gNB and the UE decreases, then the distance between the gNB and the UE over the RIS will increase. This information can be used to improve the estimation of the required timing advance of one link based on the knowledge of the timing advance for the other link.

Another consideration may be that with RIS, and smart repeaters, the distance between the UE and the gNB is likely to increase, and thus it can be expected that the timing advance fields of the RACH response and the MAC CE require more bits.

### 3GPP Protocols for Commanding a RIS

In another embodiment in relation to earlier embodiments and figures on controlling the RIS, the RIS state may be commanded by the gNB using physical downlink control channel (PDCCH) messages or signals (such as DCI) to send configuration information to a particular RIS to command a state change.

Initially, a working relation between the RIS and the gNB could be negotiated as described in other embodiments. Once the relation is set up for some time period, the gNB can signal via a PDCCH message or signal the desired RIS surface adjustments and/or state changes in a similar way as scheduling information is sent to UEs. In particular, a new DCI format can be defined for RIS use. The DCI format may contain fields to set a RIS state (e.g. indicated by a state identifier) or contain information related to other commands (as described in other embodiments, such as beam direction, timing information, amplify gain, etc.) and may also contain timing and/or resource information indicating at which time and/or frequency the gNB is expected to transmit a message to the RIS that is to be propagated by the RIS towards the UE 40. The DCI format (or a separate DCI format) may contain resources for subsequent Uplink and Downlink communication between the gNB and the RIS itself Multiple RIS's can be commanded in this way, wherein they can be distinguished by an identifier (e.g. a radio network temporary identity (RNTI)) contained in the PDCCH transmission of the gNB. One of the main benefits of using DCI is that it low latency. A disadvantage is that it typically only works in the downlink direction, and hence for uplink another mechanism/protocol is needed.

Optionally, transmission security via the PDCCH channel can be increased by including a message integrity code (MIC) in each message, for example a cryptographic cyclic redundancy code (CRC) or the like. Up to 164 bits in total are available for the example case of DCI, including CRC.

In another embodiment, the RIS state might be controlled by the gNB using RRC commands in a similar as done in Semi-Static Scheduling for uplink communication and SemiPersistent Scheduling for downlink communication. The RRC connection can be established with the UE part of the RIS. Using RRC commands to steer the RIS has the advantage that the commands can be protected (integrity protection, replay protection, confidentiality protection). Another advantage is that RRC works in both downlink and uplink. A disadvantage is that RRC has high latency.

Therefore, in another embodiment, the RIS can be queried and controlled using MAC Control Elements (MAC CE), e.g. by defining new MAC CE elements for this purpose. MAC CE is low latency and hence can be used to command the RIS in real-time, and can be used in downlink as well as uplink. In the uplink direction, the MAC CE elements can be used to provide low-latency updates of the RIS state information to the gNB.

In another embodiment, the UE part of the RIS connects to the gNB and CN as a UE, in a similar way as IAB-MT does. When the gNB/CN detect that the newly joined UE is the UE part of a RIS, in other words, the RIS-MT, a tunnel is established, e.g., a tunnel over an IP interface, e.g., a tunnel protected by IPSec, e.g., a tunnel as in the F1 3GPP interface. Through this tunnel, the gNB, e.g., the Central Unit of the gNB, transmits to the RIS the scheduled states and configuration. The RIS can also return other measurements (e.g., related to the received signal) to the access device.

In another embodiment, the RIS-MT (or the Smart Repeater)-MT uses a specific type of Information Element, for instance:
“ncr-Nodelndication
“ris-Nodelndication
   The exchange of some of those parameters might trigger the BS to request specific configuration parameters specific for a RIS or a smart repeater.

### Smart Repeaters

In general RF signal repeaters share much of the same properties as reflective intelligent surfaces, but use an RF transmitter and RF receiver frontend to rebroadcast the RF signals rather than using reflection of signals to propagate the RF signals. However, one of the benefits of a RIS that a gNB can dynamically control the state of the rIS. In another embodiment, a smart repeater interface can be based on the proposed system and method.

RF repeaters are devices that “repeat” the signal received from an access device (e.g. gNB), thereby extending its range. A preliminary evaluation indicate that performance improvement can be achieved by adding side control information (on/off, timing, spatial Tx/Rx), i.e. by making RF repeaters more smart. In that sense, smart repeaters may not just include the RF layer of an access device (e.g. gNB), but also the PHY layer for the control plane, and may e.g. include a communication module or UE similar to a RIS communication module 210 or RIS-UE 50 for sending and receiving information to an access device. The access device (e.g. gNB) can then steer the smart repeater with parameters such as the timing configuration (UL/DL), beamforming, or on/off.

The steering capabilities of a smart repeater and an RIS are expected to be similar. As already discussed above, the access device (e.g. gNB) can command the RIS to setup a given reflection pattern for a given period. This is similar to configuring the beamforming in smart repeaters. The access device (e.g. gNB) can control the RIS for some timeslots, which is similar to providing a given timing configuration to a smart repeater. Furthermore, the RIS is by default off, and thus, it only operates when the access device (e.g. gNB) is using it.

From this point of view, the above embodiments (and also the embodiments in the section on “ADDITIONAL CAPABILITIES FOR UES TO SUPPORT RIS COMMUNICATION”) may also be implemented in connection with smart repeaters or a combination of RISs and smart repeaters. To this end, RIS 20 in the above embodiments (and also the embodiments in the section on “ADDITIONAL CAPABILITIES FOR UES TO SUPPORT RIS COMMUNICATION”) can also be a smart repeater. Hence, the term RIS 20 can be replaced by smart repeater 20 in the above embodiments. In the device architecture and the embodiments, the reconfigurable surface (REC-SF) 270 can be replaced with a transceiver comprising a RF receiver frontend and an RF transmission frontend, coupled to one or more antennas, whereby the controllable states may include states/settings to control the on/off state, beam steering (e.g. number of beams, beam direction), transmission power and/or frequency and/or timings of transmitted RF signals (e.g. configurable delay), and whereby redirection patterns may include generation of multiple beams, focusing or defocusing a beam, directing a beam in a certain angle (whereby the angle may be in relation to a reference line or magnetic north, or an angle between an incoming beam and an outgoing beam (i.e. similar to deflection/refraction angle)), amplifying the incoming signal (e.g. by providing an amplify gain in a command), delaying the signal (e.g. by providing a delay time or specific timing for outgoing signals in a command). The transceiver may be the same as the RIS transmission and reception system (RIS-TRX) 2110 or may reuse/share components within the RIS-TRX 2110, or it may be a separate subsystem.

In an embodiment, parameters of a smart repeater (or a RIS) might be configured or retrieved or updated, e.g., by a BS. Such parameters may include:

```
Physical attributes
  Location
    Latitude
    Longitude
    Antenna height above ground
  Location source
    GPS/5G network/manual entry during installation
  Mobility status
    Fixed/mobile
    Current velocity
RF capabilities
  Repeater operating band(s)
    Active bandwidth parts
  Control link operating band
    Active bandwidth part
  Antenna capabilities: Access link
    Fixed/adaptive
    Fixed/default beam settings
  Antenna capabilities: Backhaul/control link
    Fixed/adaptive
    Fixed/default beam settings
  Amplifier capabilities
    Power up/down times
    Latency
    Gain settings
    Default gain
Logs
  Usage statistics
    Total amplifier ON time per hour/day/weel
    ON/OFF event statistics
    Antenna beam statistics
  Location statistics
    Movement tracking
  Operator statistics
    Usage per operator
Fault indications
  Amplifier fault
  Antenna fault
  Operational fault
    Feedback in uplink/downlink channel
```

Large Reflective Surfaces that May Serve Multiple Access Devices

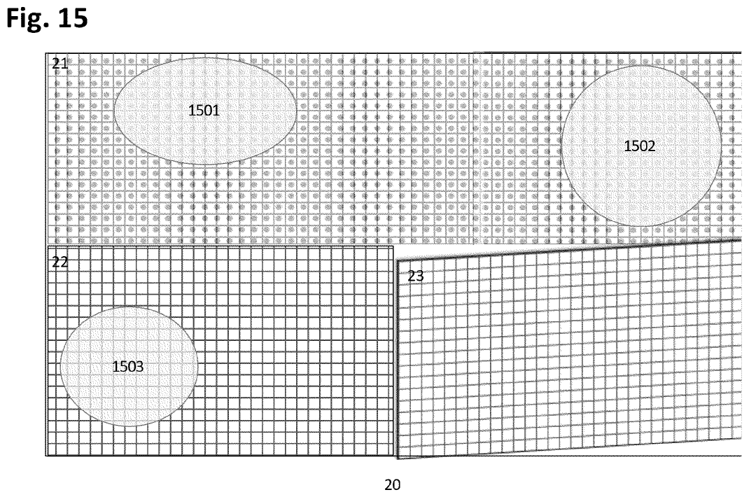

FIG. 15 schematically shows an example of how a large reflective surface could serve multiple access devices and also how it could be subdivided in multiple sub-RISs according to some embodiments. As illustrated RIS 20 may be divided into smaller RISs 21, 22, 23 (i.e. sub-RISs). In this example, sub-RIS 21 is equipped with an array of RF sensors or antennas indicated in blue circles on top of the square rectangles (which denote the elements of the reflective intelligent surface). The large circles 1501, 1502, 1503 denote focus areas of incoming beams from nearby access devices or UEs.

In an embodiment, the RIS has sensors or antennas (indicated as blue circles in FIG. 15) to measure RF signal (quality) parameters, e.g., signal strength, polarization, phase, frequency, etc and processing capabilities to use these measurements to determine a focal area (e.g. 1501 or 1502 in FIG. 15) of a beam from an access device or from a UE. The focal area can refer in this case to the RIS elements that are reached by the beam transmitted from the access device. The RIS can also include means to report to one or more access devices (e.g. through the RIS communication module) a set of coordinates of the focal area, e.g. using a coordinate system relative to a surface/dimension of the RIS or relative to a reference coordinate/position/point on a surface of the RIS (e.g. the center of a RIS panel) or using an absolute coordinate system, and/or report signal characteristics (e.g. signal strengths) measured by one or more of the RIS' sensors/antennas and the relative coordinates of these sensors/antennas. In particular, a RIS sensor/antenna might refer to a sensor/antenna embedded in each RIS element and that allows measuring signal parameters such as signal strength, phase, frequency, . . . of the incoming signal. In particular, the report might include measurements of each of the RIS elements. Based on (measurement) reports from such sensors or from measurement reports on RF signals received by antennas of the RIS, the access device may be able to derive a focal area. Information about focal area can be used to determine if multiple access devices can use the RIS simultaneously without causing interference and/or where other access devices may need to steer their beam towards to avoid causing interference. To this end, an access device that has obtained information (e.g. by receiving this information from the RIS or by deriving it from measurement reports) may share information about focal area to other access devices (e.g. using the Xn interface in case of gNBs, or by providing this information to a network function and/or storing this information in a database that may be accessible by other gNBs).

In another embodiment, the RIS may comprise a sub-RIS. In an example, the RIS may be placed on a facade of a building, which represents a large surface. Then, the RIS may be divided into sub-RIS(s) that can be controlled individually. The sub-RIS(s) may be controlled by the same RIS communication module 210 or RIS-UE 50 for sending and receiving information to an access device, whereby each sub-RIS may be given a different identifier, and whereby information about the (relative) location and/or dimensions and/or orientation and/or the capabilities and/or state information of each sub-RIS may be provided to the access device. Different sub-RIS(s) may have different orientation. For example in FIG. 15, sub-RIS 23 has a different orientation than sub-RIS 22. The orientation may be provided as part of the sub-RIS's metadata, or part of the sub-RIS's position related information (which may also include orientation information).

In another embodiment, the RIS may simultaneously be used by multiple access devices by assigning a subset of RIS elements to each of the multiple access devices. These elements may be positioned such that they can deflect/(de-)focus/refract/absorb/manipulate the signals coming from various directions (e.g. by using a two-sided or angular RIS panel), and/or by applying different types of RIS elements in the same RIS (e.g. RIS elements with (enhanced) capabilities of filtering/manipulating/deflecting signals with certain wavelengths or frequency ranges, but no/reduced capabilities of filtering/manipulating/deflecting signals of other wavelengths or frequency ranges) whereby groups of similar type of RIS elements may be clustered together. These subsets of RIS elements may be controlled by the same RIS communication module 210 or RIS-UE 50 for sending and receiving information to an access device, whereby each subset may be given a different identifier, and whereby information about the (relative) location and/or the capabilities and/or state information of each subset may be provided to the access device.

As another embodiment that can be combined with other embodiments involving a RIS UE or that can be implemented independently, in order to further improve the accuracy of the beamforming of an access device, if the RIS 20 is equipped with a RIS-UE 50 as described in other embodiments, the position of the RIS-UE 50 in relation to the reflective surface 270 of the RIS 20 may be provided by the RIS 20 to the access device, e.g. as part of the RIS capability/location information. The position of the RIS UE 50 may be provided e.g. by using a coordinate system relative to a surface/dimension of the RIS or relative to a reference coordinate/position/point on a surface of the RIS (e.g. the center of a RIS panel), or may be provided using an absolute coordinate system. The position information of the RIS UE 50 may comprise (relative) position information or other information (e.g. number or length) of the RIS UE 50's antennas. This information may be used by the access device to accurately steer the beam towards the reflective surface 270 to communicate with the UE 40, or towards the RIS UE 50 to query and control the RIS 20. Additionally, this information may be used to switch off certain RIS elements near these RF antennas if the access device is currently communicating with the RIS for command and query procedures, after which they can be switched on again if the command/query messages have been received and/or transmitted. The timing of this switching off/on of nearby RIS elements may be indicated by the access device by scheduling the resources for the command/query messages and/or changing the RIS state (either under control by the access device or by the RIS itself) in synchrony with the scheduled resources.

### Additional Capabilities for UEs to Support RIS Communication

In another embodiment in relation to earlier embodiments and figures on communicating via the RIS, a terminal (e.g. UE 40) has wireless communication means to communicate with an access device (e.g. gNB 10) directly or via a RIS 20, and storage means to store (meta) information about RISs, whereby the terminal may store (meta-)information about one or more RISs (e.g. location/orientation, schedule, capabilities, . . . ) after receiving this information from an access device (directly or originating from a core network function such as AMF, PCF, SMF) or from/via a RIS (e.g. from a reflected signal from an access device, or originating from communication means (e.g. RF communication module) in the RIS). This information may be received e.g. upon initial configuration or upon receiving system information from the access device through the RIS or upon connection establishment to the access device/registration to the network, and may change or get updated if the terminal moves around (e.g. enters another tracking area/registration area, or when the access device starts actively using a RIS to enhance the signal towards the terminal), or the terminal may e.g. upon losing connection to the access device, engage in discovery of a RIS in vicinity and receive (meta-)information from the RIS (e.g. through an RF signal originating from the RIS such as a ProSe/V2X D2D discovery message over Sidelink/PC5 (which may contain relay service code to identify a RIS combined with UE-to-Network relay functionality or a System Information Block (SIB) received via/from the RIS as described in earlier embodiments). Additionally, the terminal may have a means of beamsteering RF signals through one or more of its antennas. The terminal may use the stored (meta-) information from one or more RISs to direct its RF communication (e.g. through beamforming) towards a RIS, e.g. for uplink communication with the access device. The terminal may use information about its own location (e.g. from GPS) and/or orientation (e.g. from gyroscopic sensor) to determine, based on the stored (meta-)information of one oI more RISs in vicinity, one or more RIS(s) to use to try and steer its beam to in order to establish communication with the access device and/or the priority order between the various RISs. The terminal may also have received/stored information about priority order between the various RISs (possibly in correlation with its position) in the (meta-)information received from/via the access device in an earlier step. The terminal may use such priority order to select a preferred RIS to use if multiple RISs are available, whereby the UE may be further configured with a minimal signal strength/quality threshold (e.g. through a policy) and determine whether or not that the signal strength/quality to connect to a RIS or otherwise select a different RIS. The terminal may be triggered (e.g. based on a pre-configured policy to determine a threshold/condition for such trigger) to try to communicate via a RIS and steer its beam towards a RIS, instead of using “direct” LOS communication/beamsteering between the terminal and the access device, if the LOS signal between the terminal and the access device has deteriorated or suddenly deteriorates (e.g. due to an obstacle). Additionally or independently, the terminal has a means to measure incoming RF signals, whereby upon receiving multiple reflected/refracted/redirected RF signals, detects that the signal is sent via a RIS by determining which of the multiple reflected/refracted/redirected RF signals is the strongest reflected/refracted/redirected signal and/or determining the timing between the RF signals and/or estimate an angle/distance between the terminal and the reflected/refracted/redirected RF signal and/or by using the measured information/timings/angles/distances to correlate it with the (meta-) information stored about RISs in vicinity and/or its own location and/or orientation in order to find a RIS that (best) matches the measured information/timings/angles/distances. Upon determining a (best) matching RIS, the UE may use the (meta-)information of the RIS to further adjust its RF signals, in order to optimize the communication with the access device via the RIS. Additionally or independently, the access device may include an identity of a RIS in a downlink signal directed towards the RIS which reflects/refracts/redirected it towards the UE and/or the RIS may transmit identity information along with signals reflected/refracted/redirected from an access device, which the UE can use to identify which RIS was used by the access device and find the corresponding stored (meta-)information of the respective RIS, after which the UE may use the (meta-)information of the respective RIS to further adjust its RF signals, in order to optimize the communication with the access device via the respective RIS.

In yet another embodiment, a UE that has been configured with information/metadata related to close by RISs can use this metadata to try to reach an access device. In a first example, the UE may determine a close-by RIS based on its own location, and can send control/user plane data towards the RIS. This may also include initiating a ProSe/sidelink discovery of a close-by RIS. Upon reception of the UE data, the RIS might configure itself to steer the UE data towards the access device. To this end, the RIS should be able to obtain/detect/calculate itself the location of the UE, and the RIS has to know the desired reflection/refraction/redirection direction to reach the access device. The RIS might be able to do this by using ranging capabilities of the RIS UE, i.e., the RIS UE uses ranging to determine the distance/angle/relative position of the UE that wishes to communicate with the access device. The RIS may determine an angle to reach the access device e.g. by calculating an angle using information about its own location and location information of one or more access devices that may be pre-configured on the RIS, or that may be provided by an access device (that may control the RIS) through a command or e.g. through System Information, or that may be retrieved by the RIS from a location service. Additionally or alternatively, the RIS may upon receiving control/user plane data (which may include ProSe sidelink discovery messages) from a UE inform the access device through the command and query interface, e.g. by sending a message via its RIS-TRX/RIS-UE. Such message may include information about the UE (e.g. identity information provided during ProSe/sidelink discovery or distance/angle/position information of the UE relative to the RIS) and/or the RIS (e.g. its identity). After receiving such information, the access device may control the RIS's state to best serve the UE that wishes to communicate via the RIS. In a second example, the UE uses the received RIS information and additional RIS data to send the user/control plane data towards the RIS. Additional RIS data might refer to, e.g., (1) Sidelink Synchronization Signals or (2) Sidelink Positioning Signals transmitted from the RIS UE when the RIS UE includes sidelink capabilities that allow the UE to determine (in a more accurate manner) the position of the RIS, and therefore, the direction in which it should transmit user/control plane data. In this second example, the UE itself might connect to the RIS UE through the sidelink/PC5 interface to communicate with/control the RIS (e.g. by sending a command to set the state of the RIS) with the goal that the user/control plane data towards the access device reaches the access device. In yet another example, the UE may discover that the RIS is combined with (a subset of) UE-to-Network relay functionality, e.g. by determining that a particular Relay Service Code for this purpose as described in earlier embodiments can be discovered over sidelink (e.g. using ProSe model A/B discovery), after which it may transmit a connection request message to set up a control plane connection with the gNB and/or core network, and whereby it may be configured to switch to a layer-1 transmission (as if it were sent via the Uu interface directly to a gNB) for sending further uplink data or user plane data, whereby the RIS will propage the layer-1 signals towards the gNB and vice-versa.

To summarize, a system and method for determining and controlling a reconfigurable relay device (e.g., a reconfigurable intelligent surface, RIS, or a smart repeater) have been described, wherein the reconfigurable relay device is registered and a wireless communication path is established from a network (e.g. access device) via the reconfigurable relay device to a terminal device. The network registers the reconfigurable relay device and determines parameters needed for its control. The control may be achieved by validated and accepted commands and queries. A relay state of the relay device may be set so that a beam for the wireless communication path is correctly redirected at the terminal device.

While the invention has been illustrated and described in detail in the drawings and foregoing description, such illustration and description are to be considered illustrative or exemplary and not restrictive. The invention is not limited to the disclosed embodiments. It can be applied to various types of UEs or terminal devices, such as mobile phone, vital signs monitoring/telemetry devices, smartwatches, detectors, vehicles (for vehicle-to-vehicle (V2V) communication or more general vehicle-to-everything (V2X) communication), V2X devices, Internet of Things (IoT) hubs, IoT devices, including low-power medical sensors for health monitoring, medical (emergency) diagnosis and treatment devices, for hospital use or first-responder use, virtual reality (VR) headsets, etc.

The BS may be any network access device (such as a base station, Node B (eNB, eNodeB, gNB, gNodeB, ng-eNB, etc.), access point or the like) that provides wireless access to devices in a service area (indoor or outdoor).

The RIS may be created by use of smart devices (e.g., a smart TV or a smart Infrared panel) with hardware components (e.g., a large glass screen or panel) which could be regarded as a good reflector. The RIS may also be embedded into an object such as a billboard, building façade, poster, floor tile, roof, wall, etc. Furthermore, in the above embodiments, the RIS may be replaced by a smart repeater or RF repeater or any relay device with a controllable relay or reflection function.

Furthermore, at least some of the above embodiments may be implemented to provide network equipment for 5G/6G/xG cellular networks or a new product class of (low-cost/mid-cost) reconfigurable intelligent surfaces to improve coverage, reliability and speed of cellular networks.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated. Moreover, it will be understood by those skilled in the art that, in general, terms used herein, and especially in the appended claims, are generally intended as “open” terms, e.g., the term “including” should be interpreted as “including but not limited to, “the term “having” should be interpreted as “having at least, “the term “comprises” should be interpreted as “comprises but is not limited to, “etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an, “e.g., “a” and/or “an” should be interpreted to mean “at least one” or “one or more; “the same holds true for the use of definite articles used to introduce claim recitations. Furthermore, in those instances where a convention analogous to “at least one of A, B, and C, etc. “is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc. “is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.

The described operations like those indicated in FIGS. 2 and 11 can be implemented as program code means of a computer program and/or as dedicated hardware of the related network device or function, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. An apparatus comprising:
a registration controller circuit, wherein the registration controller circuit is arranged to discover and register a relay device in a wireless network;
a path establisher circuit, wherein the path establisher circuit is arranged to determine and establish a wireless communication path to at least one target terminal device via at least one registered relay device; and
a state controller circuit, wherein the state controller circuit is arranged to control a redirection pattern of the at least one relay device in accordance with the established wireless communication path.

2. The apparatus of claim 1,
wherein the registration controller circuit is arranged to look up the relay device in a relay installation database.

3. The apparatus of claim 1, wherein the path establisher circuit is arranged to apply a transmission modelling within a local radio transmission model of a local environment so as to search for suitable beam paths, or to use results of previous beam directions plus relay states and UE locations stored in a database.

4. The apparatus of claim 1, wherein the state controller circuit is arranged to control the redirection pattern applied to at least one beam on the wireless communication path using a scheduling request.

5. The apparatus of claim 1, wherein the path establisher circuit is arranged to apply a timing advance so as to compensate for a longer transmission path length via the relay device.

6. The apparatus of claim 1, wherein the path establisher circuit is arranged to query the relay device so as to determine a current configuration state.

7. (canceled)

8. A device comprising:
a processor circuit and a memory circuit, wherein the memory is arranged to store instructions for the processor circuit,
wherein the processor circuit is arranged to control a redirection pattern,
wherein the redirection pattern is arranged to relay at least one received wireless signal in response to a command received from a remote controller device of a wireless network,
wherein the relay of the at least one received wireless signal is used to establish a wireless communication path to a target terminal device,
wherein the processor circuit is arranged to set to one of a plurality of configuration states in response to the command,
wherein each of the plurality of configuration states results in one of a plurality of redirection patterns of the received wireless signal,
wherein the plurality of redirection patterns comprise at least one of a reflection with a given reflection angle, a focusing or defocusing, a generation of multiple beams, a refraction with a given refraction angle, an amplification with a given amplify gain, and an absorption.

9. The device of claim 8, wherein the device is a intelligent surface or other switchable metamaterial surface or a smart repeater.

10. The device of claim 8,
wherein the memory stores metadata,
wherein the metadata comprises at least one of information required for deriving capabilities of the device and/or information to control the device by a network, location and/or orientation information, a set of configuration states, a default configuration state, a reconfiguration speed, authentication, control and query methods, and a network control prioritization information.

11. The device of claim 8,
wherein the memory stores current information data,
wherein the information data comprises at least one of a current relay state, a current controller priority parameter, a first flag, a timer value and a second flag,
wherein the current relay state indicates a current configuration state,
wherein the current controller priority parameter is set to a priority of a current controller,
wherein the first flag indicates if the current relay state is being currently commanded,
wherein the timer value indicates for how long the current relay state has been commanded,
wherein the second flag indicates an out of operation state.

12. The device of claim 8, further comprising at least one sensor, wherein the at least one sensor obtains a location and/or orientation of the device.

13. The device of claim 8, wherein the memory stores usage time information.

14. The device of claim 8,
wherein the memory stores a priority list,
wherein the priority lists stores priorities of networks or devices that control the device,
wherein the device is arranged to compare a new priority of a new remote controller or a new controlling network with a current priority of a current remote controller or a currently controlling network,
wherein the device ceases the control by the current remote controller or current network and allows control by the new remote controller or new network if the comparison shows that the new priority is higher.

15. The device of claim 8, further comprising a scheduler circuit,
wherein the scheduler circuit is arranged to schedule configuration states requested by at least one networks or at least one devices,
wherein the scheduler circuit is arranged to determine whether a requested configuration state can be accepted or not.

16. The device of claim 8, wherein the device is arranged to use a device-to-device communication for communicating with the target terminal device.

17. The device of claim 8,
wherein the device is arranged to provide a random state cycling,
wherein the random state cycling arranges configuration states which are randomly changed, or
wherein the device is arranged to redirect incident waves or beams towards a predetermined fixed direction, or
wherein the device is arranged to enter a configuring state as a metamaterial absorber.

18. (canceled)

19. A method comprising:
discovering a relay device;
registering the relay device;
planning a communication path;
establishing the communication path to at least one target terminal device via at least one registered relay device; and
controlling a redirection pattern of the at least one relay device in accordance with the established communication path.

20. A computer program stored on a non-transitory medium, wherein the computer program when executed on a processor performs the method as claimed in claim 19.

21. The method of claim 19, further comprising looking up the relay device in a relay installation database, wherein the registration controller circuit is arranged to obtain identity information and metadata from the relay device.

22. The method of claim 19, further comprising receiving identity information and metadata from the relay device.

23. The method of claim 19, further comprising receiving identity information and metadata from the relay device upon the relay configurable relay device attaching or registering to the wireless network.

24. The method of claim 19, further comprising using autodiscovery of the relay device in a locality method, wherein local transmission paths with variable properties are noted.

25. The method of claim 19, further comprising applying a transmission modelling within a local radio transmission model of a local environment so as to search for suitable beam paths.

26. The method of claim 19, further comprising using results of previous beam directions plus relay states and User Equipment locations stored in a database.

27. The method of claim 19, further comprising using a feedback loop by using measurements from a target terminal device to change the angles or further narrowing a beam of the signals transmitted via the relay device.

28. The method of claim 19, further comprising using an artificial intelligence model for learning a relation or association between beam settings and parameters, relay states of nearby relay devices and/or User Equipment location(s) as input parameters and link quality and/or performance to the target terminal device as output parameters.

29. The method of claim 19, further comprising controlling the redirection pattern applied to at least one beam on the wireless communication path using a scheduling request.

30. The method of claim 19, further comprising applying a timing advance so as to compensate for a longer transmission path length via the relay device.

31. The method of claim 19, further comprising querying the relay device so as to determine a current configuration state.

32. The apparatus of claim 1, wherein the registration controller circuit is arranged to obtain identity information and metadata from the relay device.

33. The apparatus of claim 1, wherein the registration controller circuit is arranged to obtain identity information and metadata from the relay device upon the relay configurable relay device attaching or registering to the wireless network.

34. The apparatus of claim 1, wherein the registration controller circuit is arranged by using autodiscovery of the relay device in a locality method where local transmission paths with variable properties are noted.

35. The apparatus of claim 1, wherein the path establisher circuit is arranged to use measurements from a target terminal device to change the angles or further narrow a beam of the signals transmitted via the relay device.

36. The apparatus of claim 1, wherein the path establisher circuit is arranged to use of an artificial intelligence model for learning a relation or association between beam settings and parameters, relay states of nearby relay devices and/or User Equipment location(s) as input parameters and link quality and/or performance to the target terminal device as output parameters.

37. A method comprising:
controlling a redirection pattern,
wherein the redirection pattern is arranged to relay at least one received signal in response to a command received from a remote controller device of a network,
wherein the relay of the at least one received wireless signal is used to establish a wireless communication path to a target terminal device;
setting to one of a plurality of configuration states in response to the command,
wherein each of the plurality of configuration states results in one of a plurality of redirection patterns of the received wireless signal,
wherein the plurality of redirection patterns comprise at least one of a reflection with a given reflection angle, a focusing or defocusing, a generation of multiple beams, a refraction with a given refraction angle, an amplification with a given amplify gain, and an absorption.

38. The method of claim 37, further comprising storing a metadata, wherein the metadata comprises at least one of information required for deriving capabilities of the device and/or information to control the device by a network, location and/or orientation information, a set of configuration states, a default configuration state, a reconfiguration speed, authentication, control and query methods, and a network control prioritization information.

39. The method of claim 37, further comprising storing current information data,
wherein the information data comprises at least one of a current relay state, a current controller priority parameter, a first flag, a timer value and a second flag,
wherein the current relay state indicates a current configuration state,
wherein the current controller priority parameter is set to a priority of a current controller,
wherein the first flag indicates if the current relay state is being currently commanded,
wherein the timer value indicates for how long the current relay state has been commanded,
wherein the second flag indicates an out of operation state.

40. The method of claim 37, further comprising storing obtaining a location and/or orientation of the device.

41. The method of claim 37, further comprising storing usage time information.

42. The method of claim 37, further comprising storing a priority list,
wherein the priority lists stores priorities of networks or devices that control the device,
wherein the device is arranged to compare a new priority of a new remote controller or a new controlling network with a current priority of a current remote controller or a currently controlling network,
wherein the device ceases the control by the current remote controller or current network and allows control by the new remote controller or new network if the comparison shows that the new priority is higher.

42. The method of claim 37, further comprising:
scheduling configuration states requested by at least one networks or at least one devices; and
determining whether a requested configuration state can be accepted or not.

43. The method of claim 37, further comprising using a device-to-device communication for communicating with the target terminal device.

43. The method of claim 37, further comprising providing a random state cycling,
wherein the random state cycling arranges configuration states which are randomly changed, or
wherein the device is arranged to redirect incident waves or beams towards a predetermined fixed direction, or
wherein the device is arranged to enter a configuring state as a metamaterial absorber.
